(19) United States
(12) Patent Application Publication
(10) Pub. No.: US 2026/0225807 A1
(43) Pub. Date: Aug. 6, 2026

(54) Carrier for Vehicle, and Automatic Unloading System and Program Using Same

(71) Applicant: SoftBank Group Corp., Tokyo (JP)

(72) Inventor: Masayoshi Son, Minato-ku, Tokyo (JP)

(21) Appl. No.: 19/149,646

(22) PCT Filed: Dec. 5, 2023
(86) PCT No.: PCT/JP2023/043496

§ 371 Date: Jul. 21, 2025

(30) Foreign Application Priority Data
Jan. 23, 2023 (JP) 2023-007931
Feb. 21, 2023 (JP) 2023-025537
Feb. 22, 2023 (JP) 2023-026722

(51) Int. Cl. B65G 1/137; B65G 1/04; B65G 1/08; G06Q 10/083

(52) U.S. Cl. CPC B65G 1/1371; B65G 1/0478; B65G 1/08; G06Q 10/083; B65G 2203/0216

(57) ABSTRACT

A carrier for a vehicle includes plural accommodating portions that are layered and accommodate a parcel; a conveying passage provided around the plural accommodating portions in a spiral manner to couple together the accommodating portions which are adjacent to each other, thereby conveying the parcel to one of the accommodating portions in a lower layer; a moving device that moves the parcel accommodated in any one of the accommodating portions to the conveying passage; a hand-over portion that hands over the parcel to a predetermined location, the hand-over portion being provided in one of the accommodating portions in a bottom layer; and an information processing device that controls the moving device such that the parcel is moved to the conveying passage and conveyed from one of the accommodating portions in a higher layer to the one of the accommodating portions in the bottom layer.

### TECHNICAL FIELD

The present disclosure relates to a carrier for a vehicle, and an automatic unloading system and a program that use the carrier for a vehicle.

### BACKGROUND ART

Japanese Patent Application Laid-Open (JP-A) No. 2022-035198 describes a vehicle having autonomous driving functions.

### SUMMARY OF INVENTION

### Technical Problem

In the case of delivering parcels by a vehicle having autonomous driving functions, a human needs to perform the task of unloading parcels from the vehicle and the task of delivering the parcels to destinations, and thus, labor costs are required.

The present disclosure is made in view of the circumstances described above, and an object of the disclosure is to solve the above-described problem.

### Solution to Problem

According to one embodiment of the present disclosure, a first carrier for a vehicle is provided. The first carrier for a vehicle includes:
a plurality of accommodating portions that are layered and accommodate a parcel;
a conveying passage provided around the plurality of accommodating portions in a spiral manner to couple together the accommodating portions, thereby conveying the parcel to one of the accommodating portions in a lower layer, the accommodating portions being adjacent to each other;
a moving device that moves the parcel accommodated in any one of the accommodating portions to the conveying passage;
a hand-over portion that hands over the parcel to a predetermined location, the hand-over portion being provided in one of the accommodating portions in a bottom layer; and
an information processing device that controls the moving device such that the parcel is moved to the conveying passage and conveyed from one of the accommodating portions in a higher layer to the one of the accommodating portions in the bottom layer.

In the first carrier for a vehicle of the disclosure, each of the accommodating portions may have a plurality of accommodating rows, each of which accommodates a plurality of parcels in parallel, and

the moving device may have an endless belt that moves the parcel from a corresponding one of the accommodating rows to the conveying passage.

In the first carrier for a vehicle of the disclosure, at least a part of the conveying passage may have a slope that causes the parcel to fall in a sliding manner, thereby conveying the parcel to one of the accommodating portions in a lower layer.

In the first carrier for a vehicle of the disclosure, at least a part of the conveying passage may have a conveying device that conveys the parcel to one of the accommodating portions in a lower layer.

In the first carrier for a vehicle of the disclosure, the hand-over portion may be a slope that continues from the conveying passage to the predetermined location.

According to one embodiment of the disclosure, a first automatic unloading system is provided. The first automatic unloading system includes:
an autonomous vehicle including the first carrier for a vehicle according to one embodiment of the disclosure; and
a delivery robot for receiving the parcel and delivering the parcel to a delivery destination, the parcel having been handed over through the hand-over portion, and the delivery robot staying at the predetermined location.

According to one embodiment of the disclosure, a program for causing a computer to function as the information processing device for the first carrier for a vehicle of the disclosure is provided.

According to one embodiment of the disclosure, a second carrier for a vehicle is provided. The second carrier for a vehicle includes:
a plurality of accommodating portions layered and having a plurality of accommodating rows, each of which accommodates a plurality of parcels in parallel, the plurality of parcels each being provided with a piece of delivery destination information;
a conveying passage that conveys the parcel accommodated in any one of the accommodating portions in respective layers to a lower layer;
a sensor that reads the pieces of delivery destination information provided to the plurality of parcels;
a moving device that rearranges the parcels accommodated in each of the accommodating rows, and moves the parcels to the conveying passage in rearranged order;
a hand-over portion that hands over the parcel to a predetermined location, the parcel having been moved to the conveying passage and conveyed to a bottom layer; and

an information processing device that controls the moving device such that the parcels accommodated in the accommodating rows are rearranged based on a predetermined delivery route and the pieces of delivery destination information read by the sensor, and the parcels accommodated in the accommodating portions in the respective layers are moved to the conveying passage in the rearranged order and conveyed to the hand-over portion.

In the second carrier for a vehicle of the disclosure, the moving device may have a first moving device that lifts up the parcel and moves the parcel along a corresponding one of the accommodating rows, a second moving device that moves a parcel being accommodated in the corresponding one of the accommodating rows along the corresponding one of the accommodating rows, and a third moving device that moves a parcel accommodated in the corresponding one of the accommodating rows by pushing the parcel in a direction along the corresponding one of the accommodating rows.

In the second carrier for a vehicle of the disclosure, at least a part of the conveying passage may have a slope that causes the parcels to fall in a sliding manner.

In the second carrier for a vehicle of the disclosure, at least a part of the conveying passage may have a conveying device that conveys the parcels to a lower layer.

In the second carrier for a vehicle of the disclosure, the hand-over portion may continue from the conveying passage to the predetermined location.

According to one embodiment of the disclosure, a second automatic unloading system is provided. The automatic unloading system includes:
an autonomous vehicle including the second carrier for a vehicle according to one embodiment of the disclosure; and
a delivery robot for receiving the parcel and delivering the parcel to a delivery destination, the parcel having been handed over through the hand-over portion, and the delivery robot staying at the predetermined location.

According to one embodiment of the disclosure, a program for causing a computer to function as the information processing device for the second carrier for a vehicle of the disclosure is provided.

According to one embodiment of the disclosure, a third carrier for a vehicle is provided. The third carrier for a vehicle includes:
a plurality of accommodating portions that are layered and accommodate a parcel;
a first conveying passage that conveys the parcel accommodated in any one of the accommodating portions in respective layers to a lower layer, and conveys the parcel moved out from the lower layer to a higher layer;
a moving device that moves the parcel accommodated in any one of the accommodating portions to the first conveying passage, and moves the parcel from the first conveying passage to one of the accommodating portions in a predetermined layer;
a second conveying passage that conveys the parcel having been conveyed to a bottom layer to a predetermined location, and conveys the parcel moved out from the predetermined location to the first conveying passage;
a third conveying passage that conveys the parcel carried in from outside to the predetermined location, the third conveying passage being set so as to be retractable to the predetermined location; and
an information processing device that controls the first conveying passage, the second conveying passage, the third conveying passage, and the moving device such that the parcel carried in from the outside is conveyed to the predetermined location by the third conveying passage, the parcel moved out from the predetermined location is conveyed to the first conveying passage through the second conveying passage, the parcel is moved from the first conveying passage to the one of the accommodating portions in the predetermined layer, the parcel accommodated in any one of the accommodating portions is moved to the first conveying passage, with the third conveying passage retracted from the predetermined location, the parcel having been moved to the first conveying passage is conveyed to the second conveying passage, and the parcel having been conveyed to the second conveying passage is conveyed to the predetermined location.

The third carrier for a vehicle of the disclosure may further include a sensor that reads delivery destination information provided to the parcel, and
the information processing device may control the first conveying passage, the second conveying passage, the third conveying passage, and the moving device such that the parcel is accommodated in one of the accommodating portions that is determined in advance according to a delivery destination of the parcel, based on the delivery destination information read by the sensor.

In the third carrier for a vehicle of the disclosure, each of the accommodating portions may have a plurality of accommodating rows, each of which accommodates a plurality of parcels in parallel, and
the information processing device may control the first conveying passage, the second conveying passage, the third conveying passage, and the moving device such that the parcel is accommodated in one of the accommodating rows of one of the accommodating portions that is determined according to a delivery destination of the parcel, based on delivery destination information read by the sensor.

In the third carrier for a vehicle of the disclosure, each of the first conveying passage, the second conveying passage, and the third conveying passage may have a conveying device that conveys the parcels.

In the third carrier for a vehicle of the disclosure, the second conveying passage may continue from the first conveying passage to the predetermined location.

In the third carrier for a vehicle of the disclosure, the first conveying passage may be provided around the plurality of accommodating portions in a spiral manner.

According to one embodiment of the disclosure, a third automatic unloading system is provided. The automatic unloading system includes:
an autonomous vehicle including the third carrier for a vehicle according to one embodiment of the disclosure; and
a delivery robot for receiving the parcel and delivering the parcel to a delivery destination, the parcel having been handed over from the second conveying passage, and the delivery robot staying at the predetermined location, with the third conveying passage retracted.

According to one embodiment of the disclosure, a program for causing a computer to function as the information processing device for the third carrier for a vehicle of the disclosure is provided.

The above-described summary of the invention does not list all essential features of the disclosure. Any subcombination of these feature groups can also be an invention.

### BRIEF DESCRIPTION OF DRAWINGS

FIG. 1 is a partial cross-sectional side view of an autonomous vehicle used in an automatic unloading system according to a first embodiment.

FIG. 2 shows five views showing a configuration of a carrier of the first embodiment.

FIG. 3 is a diagram for describing a conveying device and a moving device of the first embodiment.

FIG. 4 is a diagram for describing falling of a parcel onto a slope in a sliding manner in the first embodiment.

FIG. 5 is a top view showing a configuration of a bottom layer of the carrier of the first embodiment.

FIG. 6 is an external perspective view of the autonomous vehicle used in the automatic unloading system according to the first embodiment.

FIG. 7 is an external perspective view of the autonomous vehicle used in the automatic unloading system according to the first embodiment.

FIG. 8 is a diagram schematically showing an example of a functional configuration of an information processing device of the first embodiment.

FIG. 9 is a diagram schematically showing an example of a processing routine performed by the information processing device in the first embodiment.

FIG. 10 shows five views showing a configuration of a carrier of a second embodiment.

FIG. 11 is a diagram for describing a moving device of the second embodiment.

FIG. 12 is a diagram showing a schematic configuration of a third moving device of the second embodiment.

FIG. 13 is a diagram for describing rearrangement of parcels in the second embodiment.

FIG. 14 is a diagram for describing rearrangement of parcels in the second embodiment.

FIG. 15 is a diagram for describing rearrangement of parcels in the second embodiment.

FIG. 16 is a diagram for describing rearrangement of parcels in the second embodiment.

FIG. 17 is a diagram for describing rearrangement of parcels in the second embodiment.

FIG. 18 is a diagram schematically showing an example of a processing routine performed by an information processing device in the second embodiment.

FIG. 19 is a partial cross-sectional side view of an autonomous vehicle used in an automatic unloading system according to a third embodiment.

FIG. 20 shows five views showing a configuration of a carrier of the third embodiment.

FIG. 21 is a diagram for describing a conveying device included in a flat portion of a first conveying passage and a moving device of the third embodiment.

FIG. 22 is a schematic diagram of a partial conveying device of the third embodiment.

FIG. 23 is a diagram for describing conveyance of a parcel at the time of unloading in the third embodiment.

FIG. 24 is a top view showing a configuration of a bottom layer of the carrier of the third embodiment.

FIG. 25 is a top view showing a configuration of the bottom layer of the carrier at the time of loading a parcel in the third embodiment.

FIG. 26 is an external perspective view of the autonomous vehicle at the time of loading a parcel in the third embodiment.

FIG. 27 is a diagram for describing conveyance of a parcel at the time of loading the parcel in the third embodiment.

FIG. 28 is a diagram schematically showing an example of a processing routine performed by an information processing device upon unloading in the third embodiment.

FIG. 29 is a diagram schematically showing an example of a processing routine performed by the information processing device upon loading a parcel in the third embodiment.

FIG. 30 is a diagram schematically showing an example of computer hardware that functions as the information processing device.

### DESCRIPTION OF EMBODIMENTS

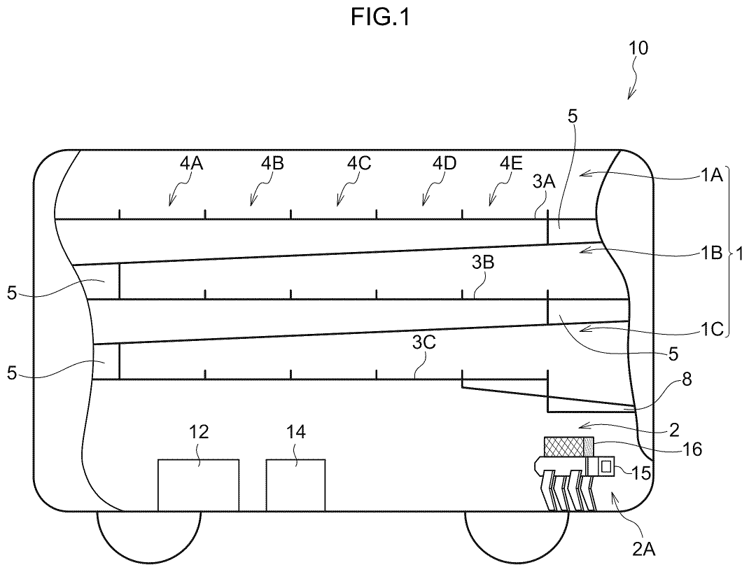

The present disclosure will be described below through embodiments of the invention; however, the following embodiments are not intended to limit the invention according to the claims. All combinations of features described in the embodiments are not always essential to the solution of the invention. FIG. 1 is a partial cross-sectional side view of an autonomous vehicle 10 used in an automatic unloading system according to a first embodiment.

The autonomous vehicle 10 used in the automatic unloading system according to the first embodiment is, for example, a level 6 autonomous vehicle. A conventional non-autonomous vehicle is equipped with a steering wheel, whereas a level 6 autonomous vehicle does not require a steering wheel, making it possible to design a wide space in the vehicle. The level 6 is a level representing autonomous driving, and corresponds to a level higher than level 5 that represents fully autonomous driving. Although level 5 represents fully autonomous driving, level 5 is a level equivalent to driving by a human, and there is still a probability of causing accidents, etc. Level 6 represents a level higher than level 5, and corresponds to a level having a lower probability of causing accidents than level 5. Level 6 is implemented by, for example, nanosecond-level control.

The autonomous vehicle 10 according to the first embodiment has a carrier 1. The carrier 1 is an example of a carrier for a vehicle of the present disclosure. The autonomous vehicle 10 has, below the carrier 1, space 2 that accommodates a delivery robot 15 which will be described later. The autonomous vehicle according to the present embodiment measures, for example, 4 meters in length, 1.8 meters in height, and 1.9 meters in width, and the second space 2 measures 80 centimeters in height; however, the dimensions are not limited thereto.

In the space 2, the delivery robot 15 for delivering a parcel P to a delivery destination stays at a predetermined location 2A. The predetermined location 2A is, as will be described later, a location where a parcel P that is handed over from the carrier 1 can be received. In the space 2, a drive device 12 for driving the autonomous vehicle 10 and an information processing device 14 are disposed. The drive device 12 includes, for example, a battery, a motor, and a control device for controlling autonomous driving. The information processing device 14 will be described later.

In the first embodiment, the carrier 1 has accommodating portions 3A to 3C that are layered and accommodate parcels. Thus, the carrier 1 is divided into three layers 1A to 1C in this order from the top. Each of the accommodating portions 3A and 3B in the layers 1A and 1B has five accommodating rows 4A to 4E, each of which accommodates a plurality of parcels in parallel. The accommodating portion 3C in the lowest layer (hereinafter, referred to as bottom layer 1C) has, as will be described later, four accommodating rows 4A to 4D, each of which accommodates a plurality of parcels in parallel. In FIG. 1, only the accommodating portion 3A is given reference numerals 4A to 4E indicating the accommodating rows.

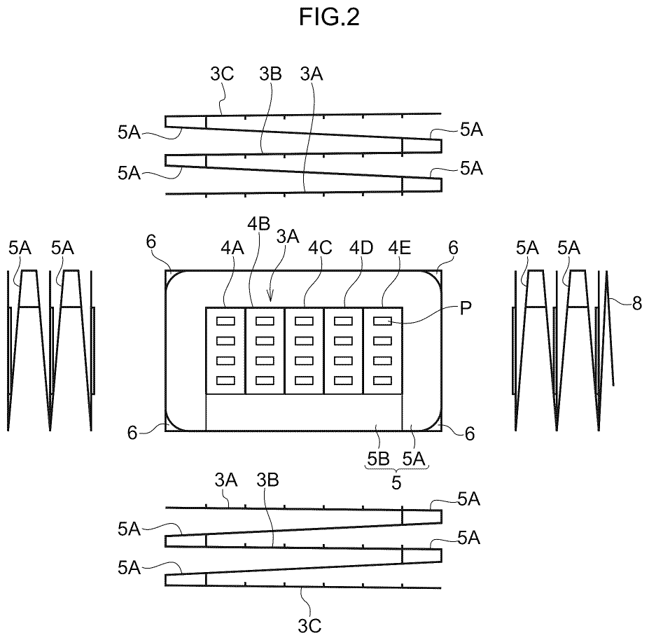

FIG. 2 shows five views showing a configuration of the carrier 1. In the present embodiment, the five views refer to views excluding a bottom view out of six views: a top view, a front view, a rear view, a left side view, and a right side view. As shown in FIG. 2, a conveying passage 5 is provided around the accommodating portions 3A to 3C. The conveying passage 5 is provided around the accommodating portions 3A to 3C in a spiral manner to couple together the accommodating portions 3A to 3C which are adjacent to each other in a top-bottom direction, whereby a parcel P is conveyed from the higher layers 1A and 1B to the bottom layer 1C. FIG. 2 shows a state in which parcels P are accommodated only in the accommodating portion 3A in the top view. In FIG. 2, only the right side view shows a hand-over portion 8 which will be described later.

The conveying passage 5 has slopes 5A that cause a parcel P to fall in a sliding manner to convey the parcel P to lower layers, and flat portions 5B for receiving the parcel P from the accommodating portions 3A to 3C. A surface of each slope 5A is, for example, fluorine-coated to enhance smoothness. Alternatively, projections and recesses where rib-like protrusions are arranged in the direction of inclination of the slope 5A may be formed on the surface of the slope 5A to reduce the area of contact between the surface and a parcel P.

At each of four corners of the slope 5A, a corner 6 having an R is formed to change, by 90 degrees, a conveying direction of a parcel P that falls in a sliding manner. Thus, the conveying direction of a parcel P that falls onto the slope 5A in a sliding manner is smoothly changed. Though not shown, a fence is provided on the inner side of each slope 5A. On the outer sides of each slope 5A and each flat portion 5B, there is a wall of the carrier 1 of the autonomous vehicle 10. By the wall of the carrier 1 and the fences, a parcel P to be conveyed is prevented from falling off the conveying passage 5.

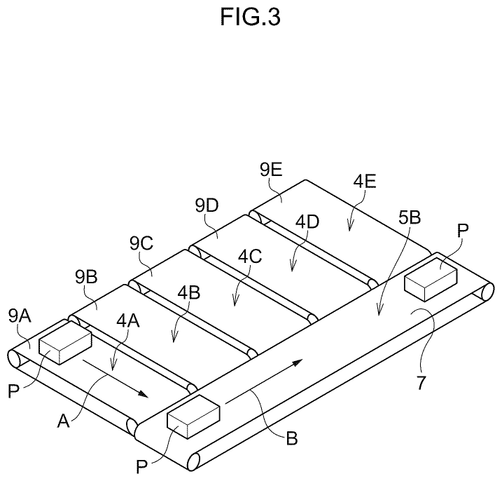

Each flat portion 5B has a conveying device 7 for conveying a parcel P to be moved out from one of the accommodating rows 4A to 4E of one of the accommodating portions 3A to 3C to a slope 5A. The conveying device 7 includes, for example, an endless belt and a drive source such as a motor. Each of the accommodating rows 4A to 4E has a moving device 9 for moving out a parcel P accommodated therein to a flat portion 5B. The moving device 9 includes, for example, an endless belt and a drive source such as a motor. FIG. 3 is a diagram for describing the conveying device and the moving device. As shown in FIG. 3, the flat portion 5B includes the conveying device 7, and the accommodating rows 4A to 4E include moving devices 9A to 9E, respectively. The endless belts included in the conveying device 7 and the moving device 9 are formed of a material with a high coefficient of friction, such as rubber, to prevent slip of parcels P.

In the moving devices 9A to 9E, the endless belts move in an arrow “A” direction by drive of the moving devices 9A to 9E, whereby parcels accommodated in the accommodating rows 4A to 4E are moved toward the flat portion 5B. In the conveying device 7, the endless belt moves in an arrow “B” direction by drive of the conveying device 7, whereby the parcels P having been moved from the accommodating rows 4A to 4E are conveyed to a slope 5A of the conveying passage 5.

In the first embodiment, the conveying device 7 and the moving devices 9A to 9E are not limited to endless belts, and may be, for example, one that hangs and conveys a parcel P like a crane. The conveying device 7 and the moving devices 9A to 9E each may be one in which a plurality of conveying rollers are disposed in parallel.

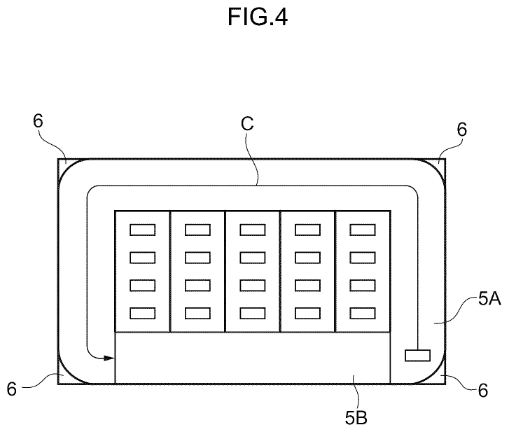

As shown in FIG. 4, a parcel P having been conveyed to a slope 5A falls onto the slope 5A in a sliding manner, and is changed in its conveying direction by 90 degrees by each corner 6 as indicated by an arrow C, and reaches a flat portion 5B of the conveying passage 5 present one layer down. The flat portion 5B of the conveying passage 5 present one layer down conveys the parcel P to a slope 5A that continues therefrom, and continuously, the parcel P further falls to a lower layer in a sliding manner by the slope 5A. Then, in each layer, likewise, the parcel P is moved from an accommodating portion to the conveying passage 5 and conveyed by a flat portion 5B and a slope 5A, whereby the parcel P is conveyed to the bottom layer 1C of the carrier 1.

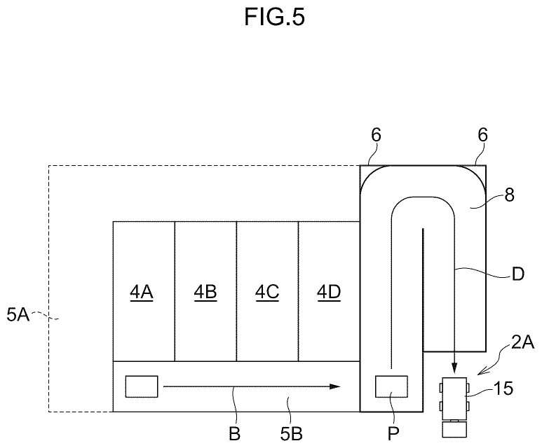

FIG. 5 is a top view showing a configuration of the bottom layer of the carrier of the first embodiment. As shown in FIG. 5, the accommodating portion 3C in the bottom layer has four accommodating rows 4A to 4D, the number of which is smaller by one than the accommodating portions 3A and 3B, and is provided with the hand-over portion 8 that continues from the flat portion 5B of the conveying passage 5. The hand-over portion 8 includes, for example, a slope for causing a parcel P having been conveyed by the flat portion 5B of the conveying passage 5 to fall to the predetermined location 2A in a sliding manner where the delivery robot 15 in the space 2 stays. The hand-over portion 8 is configured to reverse the conveying direction of the parcel P by 180 degrees. As with the conveying passage 5, corners 6 having an R are formed at portions of the hand-over portion 8 where the conveying direction is reversed. Thus, the direction of the parcel P that falls onto the hand-over portion 8 in a sliding manner is smoothly changed.

As shown in FIG. 5, a parcel P having been conveyed to the flat portion 5B of the conveying passage 5 is conveyed in the arrow “B” direction toward the hand-over portion 8, and falls onto the slope of the hand-over portion 8 in a sliding manner as indicated by an arrow D, whereby the parcel P is handed over to the delivery robot 15 that stays at the predetermined location 2A.

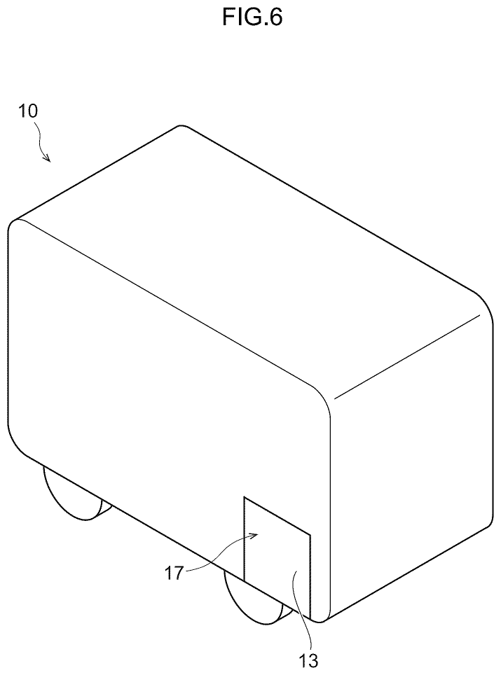

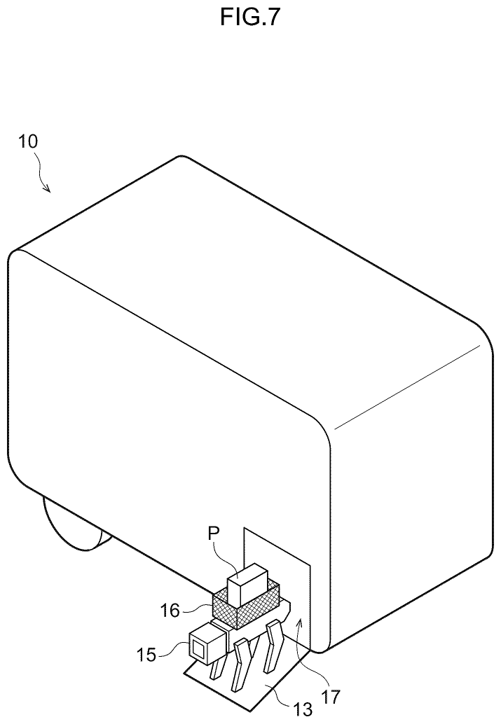

FIGS. 6 and 7 are external perspective views of the autonomous vehicle according to the first embodiment. As shown in FIG. 6, a door 13 for opening the space 2 to the outside is attached to an entrance/exit 17 present on one side of the autonomous vehicle 10, such that a lower edge portion of the door 13 is pivotable. The door 13 is attached at the predetermined location 2A where the delivery robot 15 stays. As shown in FIG. 7, when the door 13 opens, an upper edge portion of the door 13 touches the ground, whereby the door 13 functions as a slope for the delivery robot 15 to enter or exit the autonomous vehicle 10.

The delivery robot 15 is, for example, a four-legged robot or a four-wheel drive robot, and has, on the back thereof, a basket 16 for placing a parcel P. When the delivery robot 15 receives a parcel P, the delivery robot 15 delivers the received parcel P to a delivery destination of the parcel P, and thereafter automatically returns to the autonomous vehicle 10, and goes up the slope formed by the door 13 and stays at the predetermined location 2A.

In the first embodiment, parcels are accommodated in advance in the accommodating portions 3A to 3C in order determined based on a delivery route of the autonomous vehicle 10. Every time the autonomous vehicle 10 arrives at a delivery location, the parcels P accommodated based on the delivery route are conveyed one by one to the predetermined location 2A from one of the accommodating rows 4A to 4E of one of the accommodating portions 3A to 3C, whereby a parcel P is handed over to the delivery robot 15 and delivered to a target delivery destination.

Drive of the automatic unloading system according to the first embodiment is controlled by the information processing device 14 disposed in the space 2.

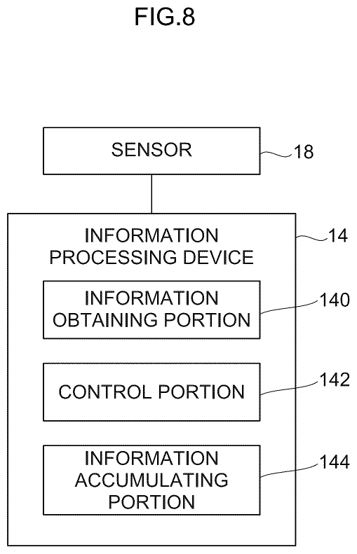

FIG. 8 is a schematic diagram of an example of the information processing device of the first embodiment. The information processing device 14 is connected to a sensor 18 mounted on the autonomous vehicle 10.

The sensor 18 obtains, for example, location information indicating the locations of parcels P accommodated in the carrier 1 of the autonomous vehicle 10, and information indicating an open/closed state of the door 13 present in the space 2. For the sensor 18, a highest performance camera, solid-state LiDAR, a multi-color laser coaxial displacement sensor, or any other various sensor group can be adopted. Other examples of the sensor 18 include a vibrometer, a thermal camera, a durometer, radar, LiDAR, a high-resolution, telephoto, ultra-wide-angle, 360-degree, and high-performance camera, vision recognition, fine sound, ultrasound, vibration, infrared rays, ultraviolet rays, electromagnetic waves, temperature, humidity, spot AI weather forecasts, a high-precision, multi-channel GPS, low-altitude satellite information, and long-tail incident AI data.

The information processing device 14 includes an information obtaining portion 140, a control portion 142, and an information accumulating portion 144. The information obtaining portion 140 obtains location information of parcels P detected by the sensor 18.

The control portion 142 controls, for example, operation of the conveying devices 7 and the moving devices 9, using the information obtained by the information obtaining portion 140 and Artificial intelligence (AI).

In the first embodiment, the control portion 142 performs, for example, the following processes:
(1) One of the moving devices 9A to 9E is driven such that a parcel P accommodated in a corresponding one of the accommodating rows 4A to 4E of a corresponding one of the accommodating portions 3A to 3C is moved to the conveying passage 5;
(2) A conveying device 7 is driven such that the parcel P having been moved to a flat portion 5B of the conveying passage 5 is conveyed toward a slope 5A. The parcel P having been moved to the slope 5A falls in a sliding manner and is conveyed by a flat portion 5B, whereby the parcel P is moved to the accommodating portion 3C in the bottom layer 1C. Then, the parcel P is conveyed to the predetermined location 2A by the hand-over portion 8 and handed over to the delivery robot 15;
(3) By detecting that the delivery robot 15 has received the parcel P, the door 13 opens; and
(4) By detecting that the delivery robot 15 has returned, the door 13 is closed.

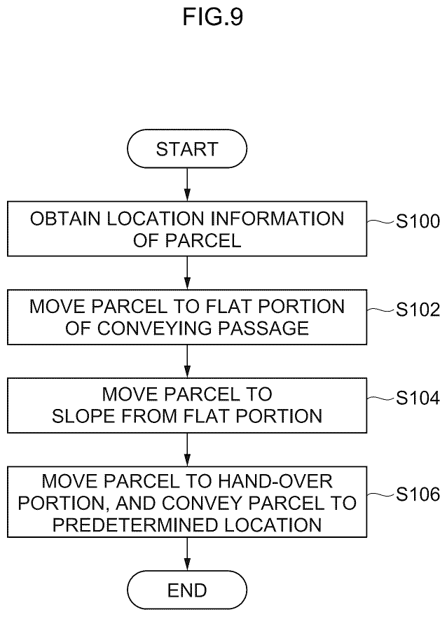

FIG. 9 is a diagram schematically showing an example of a processing routine performed by the information processing device in the first embodiment. In the case of conveying a parcel P accommodated in any one of the accommodating portions 3A to 3C to the predetermined location 2A, the information processing device 14 repeatedly performs a flowchart shown in FIG. 9.

At step S100, the information obtaining portion 140 obtains location information of a parcel P detected by the sensor 18.

At step S102, the control portion 142 moves the parcel P to a flat portion 5B of the conveying passage 5 by driving a corresponding one of the moving devices 9A to 9E, using the location information of the parcel P obtained at step S100 and AI.

At step S104, the control portion 142 moves the parcel P to a slope 5A from the flat portion 5B by driving a conveying device 7.

At step S106, the control portion 142 moves the parcel P to the hand-over portion 8 by driving a conveying device 7 included in a flat portion 5B in the bottom layer, conveys the parcel to the predetermined location 2A, and hands over the parcel P to the delivery robot 15.

When the fallen parcel P is placed on the delivery robot 15, the delivery robot 15 goes down a slope which is set as a result of opening the door 13, and delivers the parcel P to a delivery destination, and thereafter returns to the autonomous vehicle 10.

According to the first embodiment, a parcel P accommodated in any one of the accommodating portions 3A to 3C is conveyed to the accommodating portion 3C in the bottom layer by the conveying passage 5, and further conveyed to the predetermined location 2A by the hand-over portion 8, and then handed over to the delivery robot 15. The delivery robot 15 delivers the parcel P to a delivery destination, and thereafter returns to the autonomous vehicle 10. Hence, unloading of a parcel P from the vehicle can be automatically performed, and delivery of the parcel P can be automatically performed. Therefore, labor costs for tasks can be saved.

The door 13 is provided in the space 2 so that the door 13 functions as a slope for the delivery robot 15 to enter or exit the autonomous vehicle 10. Thus, in addition to anti-theft measures for the autonomous vehicle 10, entering or exiting of the delivery robot 15 can be easily performed.

Next, a second embodiment of the present disclosure will be described. In the second embodiment, only differences from the first embodiment will be described, and components common between the first and second embodiments are given the same reference numerals, and description thereof is omitted.

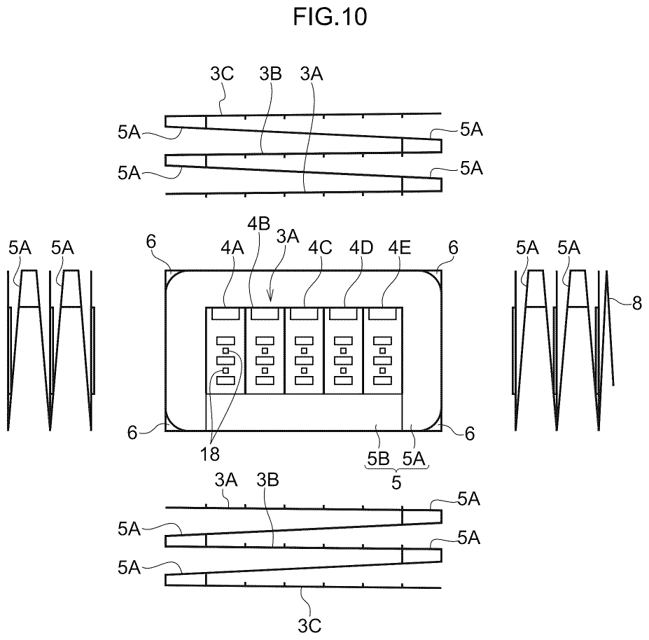

FIG. 10 shows five views showing a configuration of a carrier of the second embodiment. In the second embodiment, a plurality of sensors 18 are installed at a predetermined spacing in each of the accommodating rows 4A to 4E of the accommodating portions 3A to 3C. For example, sensors 18 for the highest layer 1A are installed on a ceiling or a wall of the carrier 1. Sensors 18 for each of the layer 1B and the bottom layer 1C are installed on undersides of the accommodating rows 4A to 4E in a layer thereabove.

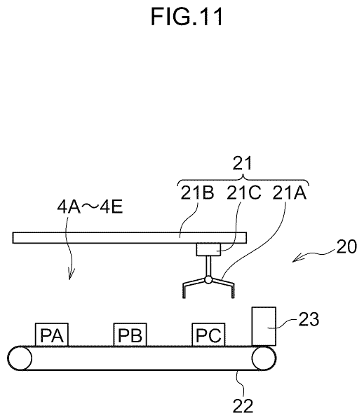

Each of the accommodating rows 4A to 4E has a moving device for rearranging parcels P accommodated therein, and moving the parcels P to a flat portion 5B of the conveying passage 5 in rearranged order. FIG. 11 is a diagram for describing the moving device of the second embodiment. FIG. 11 corresponds to a right side view in FIG. 10, and exits for parcels P in the accommodating rows 4A to 4E are located on the left side of FIG. 11. As shown in FIG. 11, a moving device 20 has a first moving device 21, a second moving device 22, and a third moving device 23. In FIG. 11, in each of the accommodating rows 4A to 4E, three parcels PA, PB, and PC are accommodated in this order from an exit side thereof.

In the highest layer 1A, first moving devices 21 are installed on the ceiling of the carrier 1, and in the layer 1B and the bottom layer 1C, first moving devices 21 are installed on ceilings of the accommodating portions 3B and 3C. The first moving device 21 is, for example, a crane. Each first moving device 21 has an arm 21A for grabbing a parcel P, a rail 21B that guides the arm 21A along a corresponding one of the accommodating rows 4A to 4E, and a drive mechanism 21C that includes, for example, a motor and a drive source and that moves the arm 21A up and down, opens and closes the arm 21A, and moves the arm 21A along the rail 21B. By the drive mechanism 21C, the arm 21A is guided by the rail 21B, whereby the arm 21A moves back and forth along the corresponding one of the accommodating rows 4A to 4E. By the arm 21A moving up and down and opening and closing by the drive mechanism 21C, the arm 21A can grab a parcel P and lift up the parcel P from the corresponding one of the accommodating rows 4A to 4E or can put a parcel P down in the corresponding one of the accommodating rows 4A to 4E.

The second moving device 22 corresponds to the moving device 9 of the above-described first embodiment; however, in the second embodiment, the moving device 9 is described as the second moving device 22. The second moving devices 22 are installed on undersides of the accommodating portions 3A to 3C. Each second moving device 22 includes, for example, an endless belt and a drive source such as a motor, and moves parcels P accommodated in a corresponding one of the accommodating rows 4A to 4E back and forth along the corresponding one of the accommodating rows 4A to 4E, with the parcels P placed on the corresponding one of the accommodating rows 4A to 4E. The endless belt included in the second moving device 22 is formed of, for example, a material with a high coefficient of friction, such as rubber, to prevent slip of parcels P. The second moving device 22 is not limited to an endless belt, and may be, for example, one in which a plurality of conveying rollers are disposed in parallel.

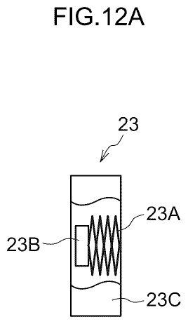

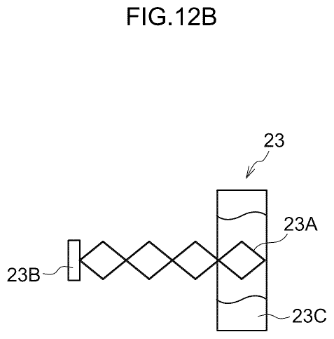

The third moving device 23 is installed on a side of each of the accommodating rows 4A to 4E that is opposite to an exit side facing the conveying passage 5. FIG. 12 is a diagram showing a schematic configuration of the third moving device of the second embodiment. As shown in FIG. 12, the third moving device 23 includes, for example, a push-out mechanism 23A, an abutment portion 23B that is attached to an end of the push-out mechanism 23A, and abuts against a parcel P, and a drive device (not shown) that stretches and compresses the push-out mechanism 23A. The abutment portion 23B is configured such that a portion of the abutment portion 23B that abuts against a parcel P is, for example, flat so that the parcel P is not damaged.

When the third moving device 23 is not in use, as shown in (A) of FIG. 12, the push-out mechanism 23A is accommodated in a casing 23C of the third moving device 23, with the push-out mechanism 23A compressed. As will be described later, in the case of switching the locations of parcels, as shown in (B) of FIG. 12, the push-out mechanism 23A is stretched by the drive device which is not shown. Thus, the abutment portion 23B is popped out of the casing 23C toward a corresponding one of the accommodating rows 4A to 4E, and pushes a parcel P, whereby the parcel P is moved in an exit direction of the corresponding one of the accommodating rows 4A to 4E.

The third moving device 23 is not limited to one having the push-out mechanism 23A, and may be, for example, one including a bar that pushes a parcel P, and a drive device that drives the bar.

Rearrangement of parcels P using the first moving device 21, the second moving device 22, and the third moving device 23 will be described later.

In the second embodiment, the conveying device 7 is not limited to an endless belt, and may be, for example, one that hangs and conveys a parcel P like a crane. The conveying device 7 may be one in which a plurality of conveying rollers are disposed in parallel.

In the second embodiment, accommodation of parcels P in the accommodating portions 3A to 3C is performed, as appropriate, regardless of a delivery route of the parcels P. By reading, by the sensors 18, pieces of delivery destination information provided to the parcels P, as will be described later, the parcels P accommodated in the accommodating rows 4A to 4E of the accommodating portions 3A to 3C are rearranged in order determined based on the delivery route.

In the second embodiment, the sensors 18 read pieces of delivery destination information which are provided to parcels P accommodated in the accommodating rows 4A to 4E of the accommodating portions 3A to 3C. The delivery destination information is, for example, a two-dimensional barcode representing an address of a delivery destination of a parcel P, and each sensor 18 reads delivery destination information which is a two-dimensional barcode. The delivery destination information provided to a parcel P is not limited to a two-dimensional barcode. The delivery destination information may be text information of a postal code or an address itself.

In the second embodiment, the information obtaining portion 140 of the information processing device 14 obtains various types of information including pieces of delivery destination information read from parcels P by the sensors 18. The information accumulating portion 144 saves, for example, a delivery route and the pieces of delivery destination information of the parcels accommodated in the carrier 1. The pieces of delivery destination information are saved in the information accumulating portion 144 so as to be associated with the delivery route.

In the second embodiment, the control portion 142 performs, for example, the following processes:
(1) Two-dimensional barcodes of accommodated parcels P are read by the sensors 18, and the information obtaining portion 140 obtains pieces of delivery destination information of the parcels P;
(2) The moving devices 20 are driven such that the parcels P accommodated in the accommodating rows 4A to 4E are rearranged based on a delivery route and the pieces of delivery destination information which are saved in the information accumulating portion 144. Upon the rearrangement, the parcels P are rearranged such that parcels P to be delivered earlier than others in the delivery route are located near the exits of the accommodating rows 4A to 4E;
(3) After the rearrangement of the parcels P, a second moving device 22 is driven such that a parcel P accommodated in a corresponding one of the accommodating rows 4A to 4E is moved to the conveying passage 5;
(4) A conveying device 7 is driven such that the parcel P having been moved to a flat portion 5B of the conveying passage 5 is conveyed toward a slope 5A. The parcel P having been moved to the slope 5A falls in a sliding manner and is conveyed by a flat portion 5B, whereby the parcel P is moved to the bottom layer 1C of the carrier 1. Then, the parcel P is conveyed to the predetermined location 2A by the hand-over portion 8 and handed over to the delivery robot 15;
(5) By detecting that the delivery robot 15 has received the parcel P, the door 13 opens; and
(6) By detecting that the delivery robot 15 has returned, the door 13 is closed.

It is preferable that the above-described processes (1) and (2) are performed after parcels P are accommodated in the carrier 1 and before the autonomous vehicle 10 arrives at the first delivery destination.

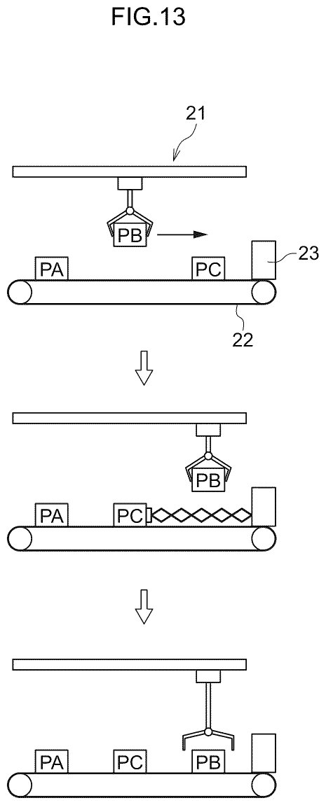

FIGS. 13 to 17 are diagrams for describing rearrangement of parcels in the second embodiment. A state in which, as shown in FIG. 11, parcels PA, PB, and PC are arranged in this order from an exit side in an accommodating row is considered an initial state. In the following description, “left” and “right” refer to the left and right sides of FIGS. 13 to 17. A leftward direction is an exit direction of each of the accommodating rows 4A to 4E, and a rightward direction is a direction opposite to the exits of the accommodating rows 4A to 4E. First, the case of rearranging the order of parcels to PA, PC, and PB from the initial state will be described. As shown in FIG. 13, the parcel PB is lifted up by the first moving device 21 and moved in the rightward direction of FIG. 13. Subsequently, the parcel PC is pushed in the leftward direction on the second moving device 22 by driving the third moving device 23, whereby the parcel PC is moved to space where the parcel PB has been accommodated. Then, by the first moving device 21, the parcel PB is put down in space where the parcel PC has been accommodated, whereby switching of the parcels is completed.

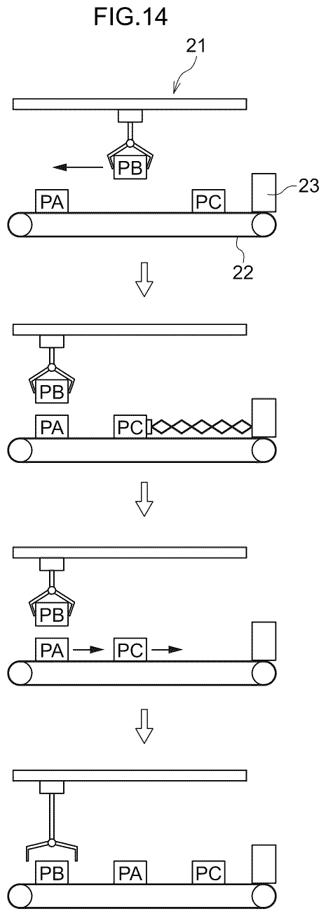

Next, the case of rearranging the order of parcels to PB, PA, and PC from the initial state will be described. First, as shown in FIG. 14, the parcel PB is lifted up by the first moving device 21 and moved in the leftward direction of FIG. 14. Subsequently, the parcel PC is pushed in the leftward direction on the second moving device 22 by driving the third moving device 23, whereby the parcel PC is moved to space where the parcel PB has been accommodated. Furthermore, the parcels PA and PC are moved in the rightward direction of FIG. 14 by driving the second moving device 22. Then, by the first moving device 21, the parcel PB is put down in space where the parcel PA has been accommodated, whereby switching of the parcels is completed.

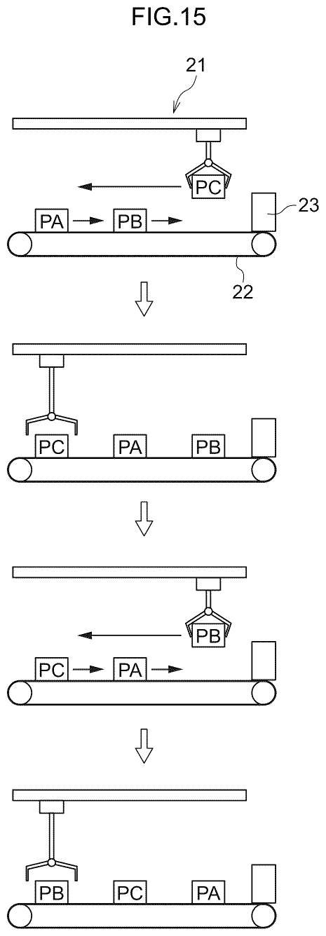

Next, the case of rearranging the order of parcels to PB, PC, and PA from the initial state will be described. First, as shown in FIG. 15, the parcel PC is lifted up by the first moving device 21 and moved in the leftward direction of FIG. 15. Subsequently, the parcels PA and PB are moved in the rightward direction of FIG. 15 by driving the second moving device 22. Then, by the first moving device 21, the parcel PC is put down in space where the parcel PA has been accommodated. Subsequently, the parcel PB is lifted up by the first moving device 21 and moved in the leftward direction of FIG. 15. Furthermore, the parcels PC and PA are moved in the rightward direction of FIG. 15 by driving the second moving device 22. Then, by the first moving device 21, the parcel PB is put down in space where the parcel PC has been accommodated, whereby switching of the parcels is completed.

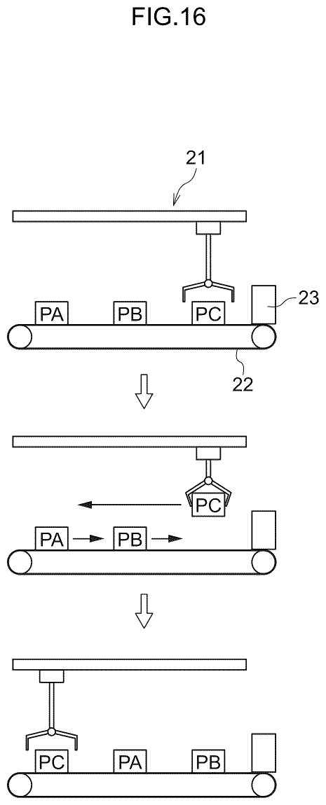

Next, the case of rearranging the order of parcels to PC, PA, and PB from the initial state will be described. First, as shown in FIG. 16, the parcel PC is lifted up by the first moving device 21 and moved in the leftward direction of FIG. 16. Subsequently, the parcels PA and PB are moved in the rightward direction of FIG. 16 by driving the second moving device 22. Then, by the first moving device 21, the parcel PC is put down in space where the parcel PA has been accommodated, whereby switching of the parcels is completed.

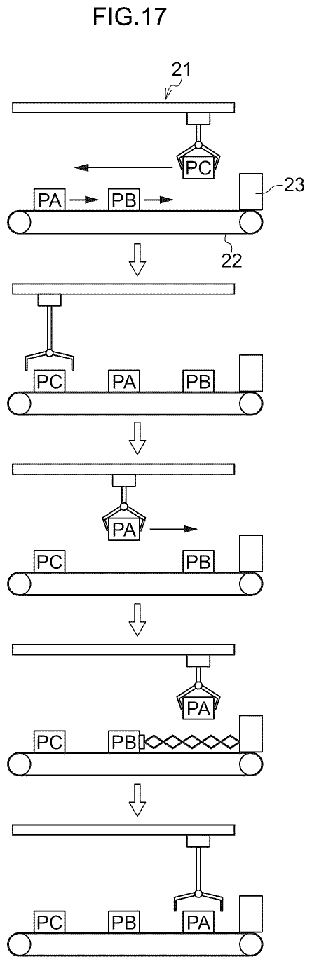

Next, the case of rearranging the order of parcels to PC, PB, and PA from the initial state will be described. First, as shown in FIG. 17, the parcel PC is lifted up by the first moving device 21 and moved in the leftward direction of FIG. 17. Subsequently, the parcels PA and PB are moved in the rightward direction of FIG. 17 by driving the second moving device 22. Then, by the first moving device 21, the parcel PC is put down in space where the parcel PA has been accommodated. Subsequently, the parcel PA is lifted up by the first moving device 21 and moved in the rightward direction of FIG. 17. Then, the parcel PB is pushed in the leftward direction on the second moving device 22 by driving the third moving device 23, whereby the parcel PB is moved to space where the parcel PA has been accommodated. Then, by the first moving device 21, the parcel PA is put down in space where the parcel PB has been accommodated, whereby switching of the parcels is completed.

In FIGS. 13 to 17, switching for the case of three parcels is described; however, in a case in which four or more parcels are accommodated in each of the accommodating rows 4A to 4E, too, as with the cases described above, the parcels P can be rearranged in order determined according to delivery destinations.

In the second embodiment, rearrangement of parcels is performed by the arm 21A of the first moving device 21 grabbing only one parcel P0; however, rearrangement of parcels may be performed by the arm 21A grabbing a plurality of parcels P0.

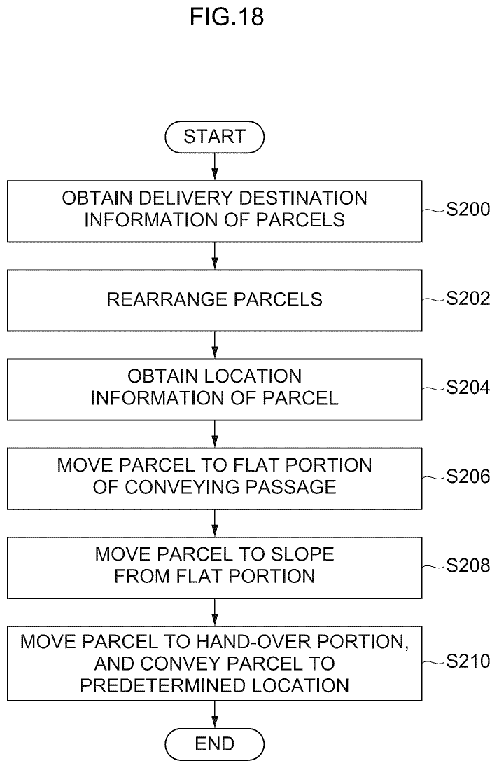

FIG. 18 is a diagram schematically showing an example of a processing routine performed by the information processing device in the second embodiment. In the case of conveying a parcel P accommodated in any one of the accommodating portions 3A to 3C to the predetermined location 2A, the information processing device 14 repeatedly performs a flowchart shown in FIG. 18.

At step S200, the information obtaining portion 140 obtains pieces of delivery destination information of parcels P read by the sensors 18.

At step S202, the control portion 142 rearranges the parcels P accommodated in the accommodating rows 4A to 4E, based on a delivery route and the pieces of delivery destination information.

At step S204, the information obtaining portion 140 obtains location information of a parcel P to be delivered which is detected by a sensor 18.

At step S206, the control portion 142 moves the parcel P to a flat portion 5B of the conveying passage 5 by driving a second moving device 22, using the location information of the parcel P obtained at step S204 and AI.

At step S208, the control portion 142 moves the parcel P to a slope 5A from the flat portion 5B by driving a conveying device 7.

At step S210, the control portion 142 moves the parcel P to the hand-over portion 8 by driving a conveying device 7 included in a flat portion 5B in the bottom layer 1C of the carrier 1, conveys the parcel to the predetermined location 2A, and hands over the parcel P to the delivery robot 15.

When the fallen parcel P is placed on the delivery robot 15, the delivery robot 15 goes down a slope which is set as a result of opening the door 13, and delivers the parcel P to a delivery destination, and thereafter returns to the autonomous vehicle 10.

According to the second embodiment, a parcel P accommodated in any one of the accommodating portions 3A to 3C is conveyed to the bottom layer 1C of the carrier 1 by the conveying passage 5, and further conveyed to the predetermined location 2A by the hand-over portion 8, and then handed over to the delivery robot 15. The delivery robot 15 delivers the parcel P to a delivery destination, and thereafter returns to the autonomous vehicle 10. Hence, unloading of a parcel P from the vehicle can be automatically performed, and delivery of the parcel P can be automatically performed. Therefore, labor costs for tasks can be saved.

In the second embodiment, pieces of delivery destination information of parcels P are obtained, and the parcels P accommodated in the accommodating rows 4A to 4E are rearranged based on a predetermined delivery route and the pieces of delivery destination information, and the parcels are moved to the conveying passage in rearranged order and conveyed to the hand-over portion. Thus, even when parcels P are accommodated in the carrier 1 in random order without taking into account delivery destinations, the parcels P can be moved to the conveying passage from the accommodating portions 3A to 3C in the order of a delivery route, and conveyed.

In the above-described first and second embodiments, the conveying passage 5 includes the slopes 5A and the flat portions 5B, and in the slopes 5A, a parcel P is conveyed by falling in a sliding manner; however, the configuration is not limited thereto. A parcel P may be conveyed to a lower layer by including, in the slope 5A, a conveying device having an endless belt, or a conveying device in which a plurality of conveying rollers are disposed in parallel, as with the flat portion 5B. The conveying passage 5 may be configured such that a parcel P is conveyed only by falling in a sliding manner, by using slopes 5A instead of the flat portions 5B.

In the first and second embodiments, the hand-over portion 8 is a slope where a parcel P is conveyed to the predetermined location 2A by falling in a sliding manner; however, the configuration is not limited thereto. The hand-over portion 8 may include a conveying device having an endless belt, so that a parcel P is conveyed to the predetermined location 2A by the endless belt.

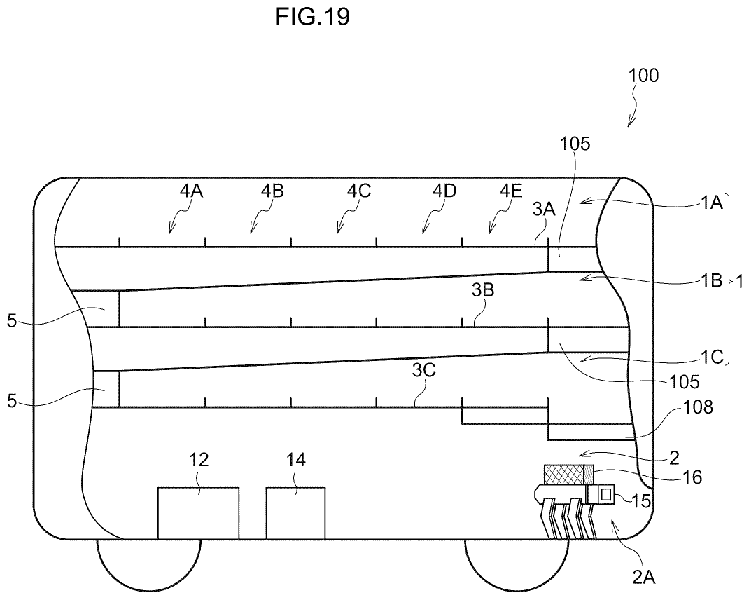

Next, a third embodiment of the present disclosure will be described. FIG. 19 is a partial cross-sectional side view of an autonomous vehicle 100 used in an automatic unloading system according to the third embodiment. In the third embodiment, the same components as those in the first embodiment are given the same reference numerals, and a detailed description thereof is omitted. The third embodiment differs from the first and second embodiments in that a conveying passage 105 and a second conveying passage 108 which will be described later are provided instead of the conveying passage 5 and the hand-over portion 8 of the first and second embodiments.

In the third embodiment, a parcel P is accommodated in one of the accommodating portions 3A to 3C and further in one of the accommodating rows 4A to 4E of the one of the accommodating portions 3A to 3C that are determined in advance according to a delivery destination. Parcels P are sorted and accommodated according to delivery destinations, e.g., parcels to be delivered to the area A are accommodated in the accommodating row 4A of the accommodating portion 3A, and parcels to be delivered to the area B are accommodated in the accommodating row 4B of the accommodating portion 3C.

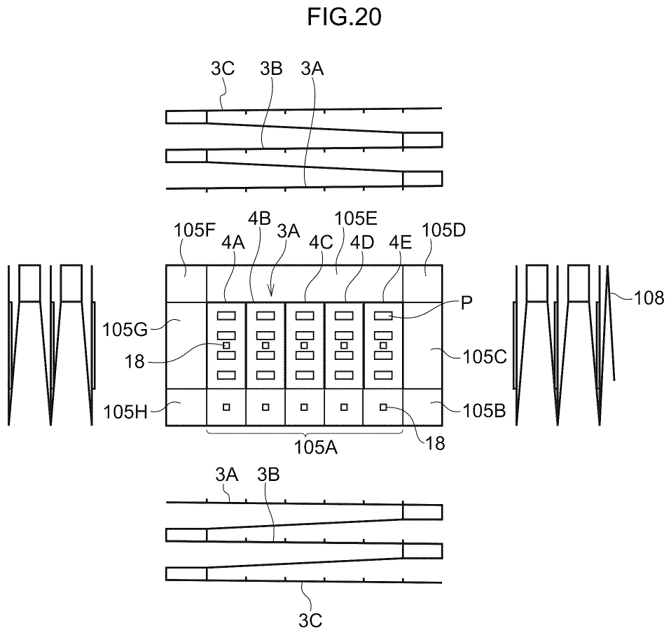

FIG. 20 shows five views showing a configuration of a carrier 1 of the third embodiment. As shown in FIG. 20, a first conveying passage 105 is provided around the accommodating portions 3A to 3C. The first conveying passage 105 is provided around the accommodating portions 3A to 3C in a spiral manner to couple together the accommodating portions 3A to 3C which are adjacent to each other in a top-bottom direction, whereby a parcel P is conveyed from the higher layers 1A and 1B to the bottom layer 1C, and a parcel P is conveyed from the bottom layer 1C to the layer 1B and further to the layer 1A. FIG. 20 shows a state in which parcels P are accommodated only in the accommodating portion 3A in the top view. In FIG. 20, only the right side view shows the second conveying passage 108 which will be described later.

The first conveying passage 105 is formed by repeatedly connecting a flat portion 105A, an intersecting portion 105B, a slope 105C, an intersecting portion 105D, a slope 105E, an intersecting portion 105F, a slope 105G, and an intersecting portion 105H in this order from the layer 1A to the layer 1C. Each flat portion 105A is connected to entrances/exits for parcels P in the accommodating rows 4A to 4E of a corresponding one of the accommodating portions 3A to 3C, whereby parcels P are received from the accommodating portions 3A to 3C, or parcels P are moved to the accommodating portions 3A to 3C.

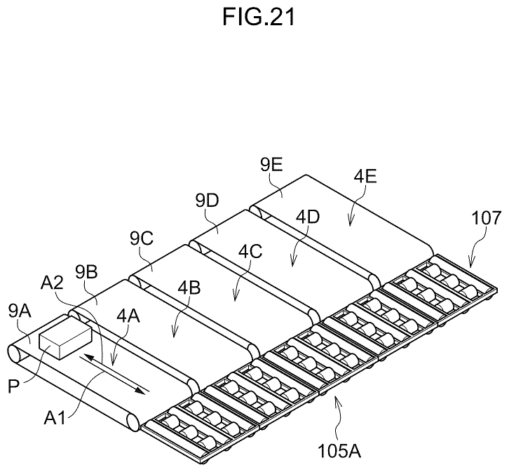

Each flat portion 105A has a conveying device 107 for conveying a parcel P to be moved out from one of the accommodating rows 4A to 4E of one of the accommodating portions 3A to 3C, or moving a parcel P to one of the accommodating rows 4A to 4E of one of the accommodating portions 3A to 3C. The conveying device 107 includes combined rollers that can convey a parcel P in two intersecting directions, and a drive source such as a motor. Each of the accommodating rows 4A to 4E has a moving device 9, which is the same as that of the first embodiment, for moving out an accommodated parcel P to a flat portion 105A. As in the first embodiment, the moving device 9 includes, for example, an endless belt and a drive source such as a motor. FIG. 21 is a diagram for describing the conveying device included in the flat portion and the moving device of the third embodiment. As shown in FIG. 21, the flat portion 105A includes the conveying device 107, and the accommodating rows 4A to 4E include moving devices 9A to 9E, respectively. The endless belt included in the moving device 9 is formed of a material with a high coefficient of friction, such as rubber, to prevent slip of parcels P.

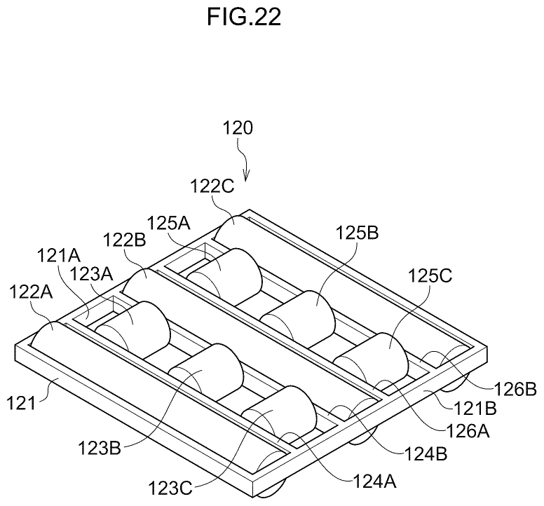

The conveying device 107 is formed by connecting together partial conveying devices in a row, each of which has combined rollers for conveying a parcel P in intersecting conveying directions as described above. FIG. 22 is a schematic diagram showing a configuration of the partial conveying device of the third embodiment. As shown in FIG. 22, a partial conveying device 120 has a rectangular frame 121. Three first conveying rollers 122A, 122B, and 122C are rotatably attached to opposite sides 121A and 121B of the frame 121 so as to be spaced apart from each other. Between the first conveying roller 122A and the first conveying roller 122B, three second conveying rollers 123A, 123B, and 123C each having a rotary shaft which is orthogonal to a rotary shaft of each of the first conveying rollers 122A, 122B, and 122C are rotatably attached to bearings 124A and 124B. Between the first conveying roller 122B and the first conveying roller 122C, three second conveying rollers 125A, 125B, and 125C each having a rotary shaft which is orthogonal to the rotary shaft of each of the first conveying rollers 122A, 122B, and 122C are rotatably attached to bearings 126A and 126B. All of the first conveying rollers and the second conveying rollers rotate around their rotary shafts in both directions by a drive source such as a motor which is not shown. In the third embodiment, rollers thus including a combination of conveying rollers having orthogonal rotary shafts are referred to as combined rollers. The conveying device 107 is formed by arranging the partial conveying devices 120 in a row that have such combined rollers.

In the following description, for the first conveying rollers, only the reference numeral 122 is used, and for the second conveying rollers, only the reference numerals 123 and 125 are used.

A plurality of sensors 18 are installed at the flat portions 105A of the first conveying passage 105 and at the accommodating rows 4A to 4E of the accommodating portions 3A to 3C. In FIG. 20, only some of the sensors 18 are shown. For example, sensors 18 for the highest layer 1A are installed on a ceiling or a wall of the carrier 1. Sensors 18 for the layer 1B and the bottom layer 1C are installed above the first conveying passage 105 and the accommodating portions 3A to 3C, i.e., on undersides of the first conveying passage 105 and the accommodating portions 3A to 3C that are located thereabove, or a wall of the carrier 1.

As shown in FIG. 21, in the moving devices 9A to 9E, when the endless belts move in an arrow “A1” direction by drive of the moving devices 9A to 9E, parcels P accommodated in the accommodating rows 4A to 4E move toward the flat portion 105A. When the endless belts move in an arrow “A2” direction, parcels P having been moved from the flat portion 105A move in an opposite direction to the entrances/exits of the accommodating rows 4A to 4E.

In the flat portion 105A, when only the first conveying rollers 122 in the partial conveying devices 120 included in the conveying device 107 are rotated, a parcel P is conveyed along the first conveying passage 105. In the flat portion 105A, when only the second conveying rollers 123 and 125 in the partial conveying devices 120 included in the conveying device 107 are rotated, parcels P present on the flat portion 105A move to the accommodating rows 4A to 4E of the accommodating portions 3A to 3C. Thus, a parcel P having been conveyed to near the entrance/exit of a desired one of the accommodating rows 4A to 4E is changed in its conveying direction to the direction of the accommodating rows 4A to 4E while the endless belt included in a corresponding one of the moving devices 9A to 9E moves in the arrow “A2” direction, whereby the parcel P is accommodated in the desired one of the accommodating rows 4A to 4E. On the other hand, a parcel P accommodated in any one of the accommodating rows 4A to 4E is moved to the first conveying passage 105 by changing the direction of rotation of the second conveying rollers 123 and 125 to a direction opposite to the direction used upon accommodating a parcel P, while the endless belt included in a corresponding one of the moving devices 9A to 9E moves in the arrow “A1” direction.

In the third embodiment, too, the moving device 9 is not limited to an endless belt, and may be, for example, one that hangs and conveys a parcel P like a crane. The moving device 9 may be one in which a plurality of conveying rollers are disposed in parallel.

The slopes 105C, 105E, and 105G are set so as to be inclined from a higher layer to a lower layer. Each of the slopes 105C, 105E, and 105G has a conveying device 110 for conveying a parcel P (not shown). The conveying device 110 includes, for example, an endless belt and a drive source such as a motor. Thus, by the slopes 105C, 105E, and 105G, a parcel P is conveyed from a lower layer to a higher layer of the carrier 1 or from a higher layer to a lower layer.

Though not shown, a fence is provided on the inner side of each of the slopes 105C, 105E, and 105G. On the outer side of the first conveying passage 105, there is a wall of the carrier 1 of the autonomous vehicle 100. By the wall of the carrier 1 and the fences, a parcel P to be conveyed is prevented from falling off the first conveying passage 105. A parcel P on any one of the slopes 105C, 105E, and 105G is conveyed to both a higher layer and a lower layer by changing its conveying direction which is controlled by a conveying device 110.

The conveying device 110 is not limited to an endless belt, and may be, for example, one that hangs and conveys a parcel P like a crane. The conveying device 110 may be one in which a plurality of conveying rollers are disposed in parallel.

Each of the intersecting portions 105B, 105D, 105F, and 105H of the first conveying passage 105 has the above-described partial conveying device 120 including combined rollers. Hence, a parcel P having been conveyed to any one of the intersecting portions 105B, 105D, 105F, and 105H can be conveyed from the flat portion 105A to the slope 105C or from the slope 105C to the next slope 105E by changing the conveying direction by 90 degrees by switching drive of the first conveying rollers 122 and the second conveying rollers 123 and 125.

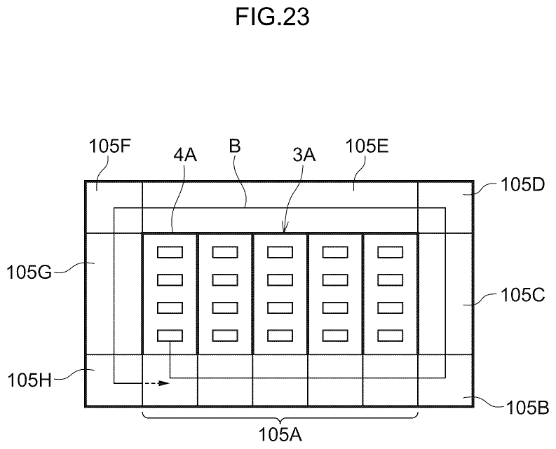

FIG. 23 is a diagram for describing conveyance of a parcel by the first conveying passage of the third embodiment. Although FIG. 23 shows the first conveying passage 105 seen in a top view of the highest layer 1A, in the next layer 1B, too, a parcel P is conveyed by the first conveying passage 105 in the same manner. First, the case of conveying a parcel P from the highest layer 1A to the bottom layer 1C for unloading from the carrier 1 will be described. As shown in FIG. 23, by driving the moving device 9A of any one of the accommodating rows (here, 4A) of the accommodating portion 3A in the highest layer 1A, a parcel P is moved from the accommodating row 4A to the flat portion 105A.

The parcel P having been moved to the flat portion 105A is conveyed along a longitudinal direction of the flat portion 105A by the conveying device 107 included in the flat portion 105A, and is changed in its conveying direction by 90 degrees by the first intersecting portion 105B, and then conveyed by the slope 105C. Then, the parcel P is changed in its conveying direction by 90 degrees by the next intersecting portion 105D and conveyed by the next slope 105E. Furthermore, the parcel P is changed in its conveying direction by 90 degrees by the next intersecting portion 105F and conveyed by the next slope 105G, and changed in its conveying direction by 90 degrees by the next intersecting portion 105H. Then, by the first conveying passage 105 present around the accommodating portion 3B in the next layer 1B, the parcel P is conveyed to the bottom layer 1C of the carrier 1 in the same manner as the first conveying passage 105 in the layer 1A. In FIG. 23, a conveying path of the parcel P is indicated by an arrow B.

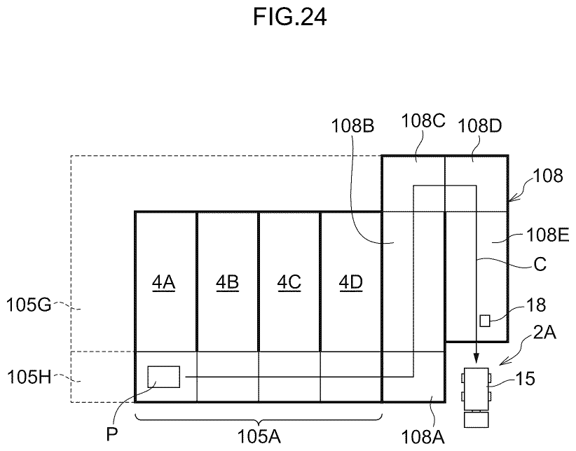

FIG. 24 is a top view showing a configuration of the bottom layer of the carrier of the third embodiment. As shown in FIG. 24, the accommodating portion 3C in the bottom layer 1C of the carrier 1 has four accommodating rows 4A to 4D, the number of which is smaller by one than the accommodating portions 3A and 3B. In the bottom layer 1C, a second conveying passage 108 is provided continuing from the flat portion 105A of the first conveying passage 105 in the bottom layer 1C. The second conveying passage 108 is formed by connecting together an intersecting portion 108A, a slope 108B, an intersecting portion 108C, an intersecting portion 108D, and a slope 108E. A sensor 18 is installed near a predetermined location 2A in the slope 108E. The sensor 18 is installed on a ceiling of the slope 108E or a wall of the carrier 1. The predetermined location 2A is where a third conveying passage which will be described later (not shown in FIG. 24) is set so as to be retractable to the predetermined location 2A.

The slopes 108B and 108E are set so as to be inclined from an exit of the flat portion 105A toward the predetermined location 2A. Each of the slopes 108B and 108E has a conveying device 119 for conveying a parcel P (not shown). The conveying device 119 includes, for example, an endless belt and a drive source such as a motor.

As with the intersecting portions 105B, 105D, 105F, and 105H of the first conveying passage 105, each of the intersecting portions 108A, 108C, and 108D has the above-described partial conveying device 120 including combined rollers. Hence, a parcel P having been conveyed to any one of the intersecting portions 108A, 108C, and 108D is conveyed from the flat portion 105A to the slope 108B and from the slope 108B to the slope 108E by changing the conveying direction by 90 degrees by switching drive of the first conveying rollers 122 and the second conveying rollers 123 and 125.

As shown in FIG. 24, a parcel P having been conveyed to the flat portion 105A of the first conveying passage 105 of the carrier 1 or a parcel P having been moved to the flat portion 105A from a desired accommodating row of the accommodating portion 3C is conveyed along the longitudinal direction of the flat portion 105A, and changed in its conveying direction by 90 degrees by the first intersecting portion 108A of the second conveying passage 108, and then conveyed by the slope 108B. Then, the parcel P is changed in its conveying direction by 180 degrees by the next intersecting portions 108C and 108D and conveyed to the predetermined location 2A by the next slope 108E. Then, the parcel P is handed over to the delivery robot 15 that stays at the predetermined location 2A. In FIG. 24, a conveying path of the parcel P is indicated by an arrow C.

The conveying device 119 is not limited to an endless belt, and may be, for example, one that hangs and conveys a parcel P like a crane. The conveying device 119 may be one in which a plurality of conveying rollers are disposed in parallel.

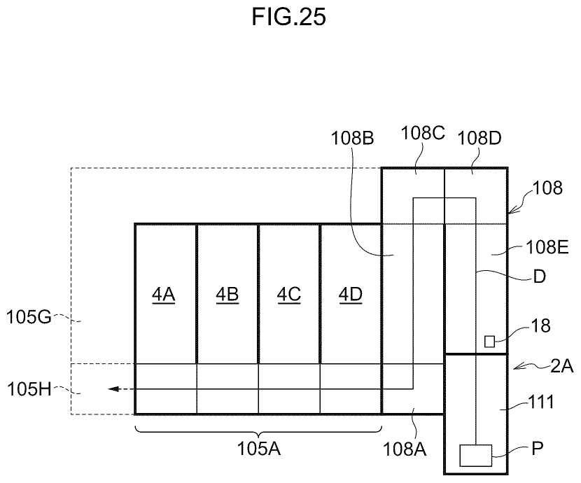

Next, loading of a parcel P into the carrier 1 and conveyance of the parcel P from the bottom layer 1C to a higher layer in the third embodiment will be described. FIG. 25 is a diagram showing the bottom layer at the time of loading a parcel P into the carrier 1. In the third embodiment, upon loading a parcel P into the carrier 1, a third conveying passage 111 is set in the carrier 1. The third conveying passage 111 is set at the predetermined location 2A in the space 2 of the carrier 1, continuing from the slope 108E of the second conveying passage 108. The third conveying passage 111 has a conveying device 131 (not shown) that includes, for example, an endless belt and a drive source such as a motor. Upon setting the third conveying passage 111, the delivery robot 15 is retracted from the predetermined location 2A. In addition, the door 13 of the autonomous vehicle 100 is opened.

The third conveying passage 111 may be a passage that is accommodated folded below the slope 108E, and upon use, the passage is pulled out to the predetermined location 2A and set, or may be a passage that is accommodated in the space 2 of the carrier 1, and upon use, the passage is attached to an entrance/exit of the slope 108E, whereby the passage is set at the predetermined location 2A.

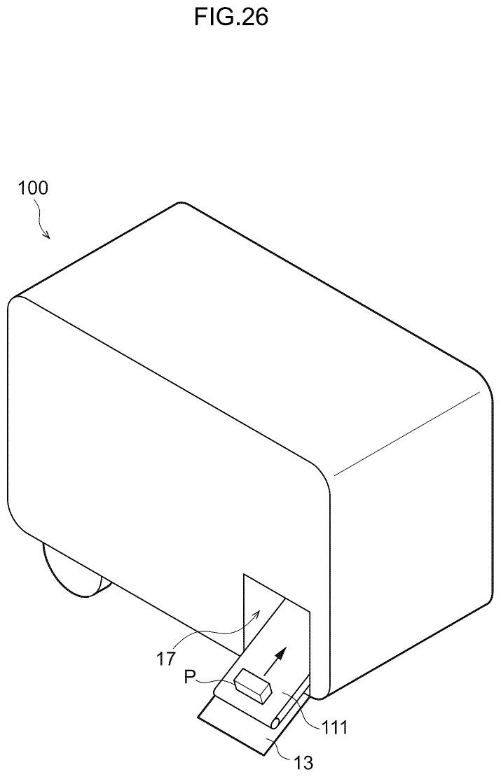

When the third conveying passage 111 is set at the predetermined location 2A, as shown in FIG. 26, a part of the third conveying passage 111 protrudes to the outside from the entrance/exit 17 of the autonomous vehicle 100. In this state, a parcel P is loaded into the carrier 1 through the third conveying passage 111.

The conveying device 131 is not limited to an endless belt, and may be, for example, one that hangs and conveys a parcel P like a crane. The conveying device 131 may be one in which a plurality of conveying rollers are disposed in parallel.

As shown in FIG. 25, a parcel P loaded onto the third conveying passage 111 is conveyed to the slope 108E of the second conveying passage 108 from the third conveying passage 111. The sensor 18 is installed near the predetermined location 2A in the slope 108E, and delivery destination information provided to the parcel P is read by the sensor 18.

The parcel P having been conveyed onto the slope 108E is changed in its conveying direction by 180 degrees by the intersecting portions 108D and 108C and conveyed to the intersecting portion 108A by the next slope 108B. The parcel P having been conveyed to the intersecting portion 108A is changed in its conveying direction by 90 degrees and conveyed to the flat portion 105A of the first conveying passage 105 in the bottom layer 1C. The parcel P is conveyed along the longitudinal direction of the flat portion 105A, and changed in its conveying direction by 90 degrees by the intersecting portion 105H, and then conveyed to a higher layer by the slope 105G. In FIG. 25, a conveying path of the parcel P is indicated by an arrow D.

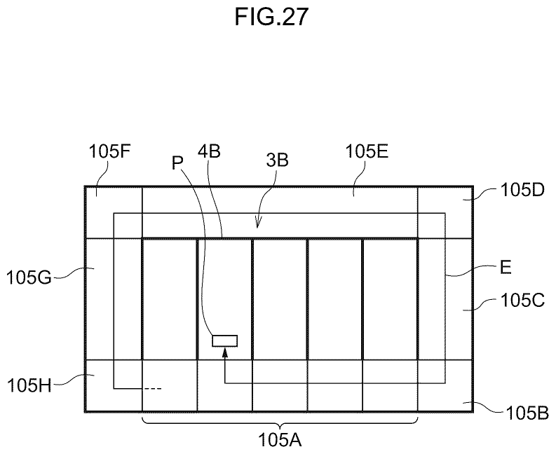

In this example, it is assumed that an accommodating row where the loaded parcel P is to be accommodated is the accommodating row 4B of the accommodating portion 3B in the layer 1B. As shown in FIG. 27, the parcel P having been conveyed by the slope 105G is changed in its conveying direction by 90 degrees by the intersecting portion 105F and conveyed by the next slope 105E. Then, the parcel P is changed in its conveying direction by 90 degrees by the next intersecting portion 105D and conveyed by the next slope 105C. Furthermore, the parcel P is changed in its conveying direction by 90 degrees by the next intersecting portion 105B and continuously conveyed along the longitudinal direction of the flat portion 105A.

The parcel P having been conveyed to an entrance/exit of the accommodating row 4B of the accommodating portion 3B is changed in its conveying direction by 90 degrees which is controlled by a partial conveying device 120 present at the location of the parcel P, so that the conveying direction points toward the accommodating row 4B. The moving device 9B of the accommodating row 4B is moved in the arrow “A2” direction of FIG. 21. Thus, the loaded parcel P is accommodated in the desired accommodating row 4B of the accommodating portion 3B. In FIG. 27, a conveying path of the parcel P is indicated by an arrow E.

In the third embodiment, the information obtaining portion 140 of the information processing device 14 obtains various types of information including pieces of delivery destination information read from parcels P by the sensor 18. The information accumulating portion 144 saves, for example, a delivery route and pieces of delivery destination information of parcels to be loaded. The pieces of delivery destination information are saved in the information accumulating portion 144 so as to be associated with the delivery route.

In the third embodiment, the control portion 142 controls, for example, operation of the conveying devices and the partial conveying devices (hereinafter, referred to as conveying devices, etc.) that are included in the first conveying passage 105, the second conveying passage 108, and the third conveying passage 111, and the moving devices 9, using information obtained by the information obtaining portion 140 and AI.

In the third embodiment, upon unloading a parcel P, the control portion 142 performs, for example, the following processes:
(1) One of the moving devices 9A to 9E is driven such that a parcel P accommodated in a corresponding one of the accommodating rows 4A to 4E of a corresponding one of the accommodating portions 3A to 3C is moved to the first conveying passage 105;
(2) A conveying device included in the first conveying passage 105 is driven such that the parcel P having been moved to a flat portion 105A of the first conveying passage 105 is conveyed toward the bottom layer 1C;
(3) Conveying devices included in the second conveying passage 108 are driven such that the parcel P having been conveyed to the bottom layer 1C is conveyed to the predetermined location 2A, whereby the parcel P is handed over to the delivery robot 15;
(4) By detecting that the delivery robot 15 has received the parcel P, the door 13 opens; and
(5) By detecting that the delivery robot 15 has returned, the door 13 is closed.

In the third embodiment, upon loading a parcel P, the control portion 142 performs, for example, the following processes:
(1) A two-dimensional barcode of a parcel P having been loaded through the third conveying passage 111 is read by the sensor 18, and the information obtaining portion 140 obtains delivery destination information of the parcel P;
(2) Based on a delivery route and the delivery destination information that are saved in the information accumulating portion 144, it is determined in which one of the accommodating rows 4A to 4E and in which one of the accommodating portions 3A to 3C is to accommodate the parcel P; and
(3) Conveying devices, etc., included in the second conveying passage 108 and the first conveying passage 105 and a corresponding moving device are driven such that the parcel P is conveyed toward the determined accommodating row, and the conveyed parcel P is accommodated in the determined accommodating row.

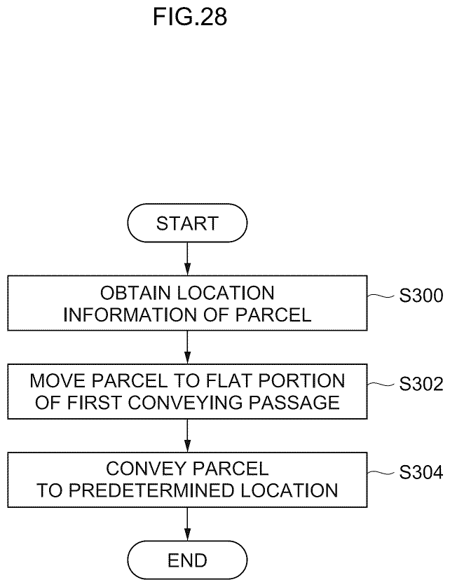

FIG. 28 is a diagram schematically showing an example of a processing routine performed by the information processing device upon unloading in the third embodiment. In the case of unloading a parcel P accommodated in any one of the accommodating portions 3A to 3C from the carrier 1 and conveying the parcel P to the predetermined location 2A, the information processing device 14 repeatedly performs a flowchart shown in FIG. 28.

At step S300, the information obtaining portion 140 obtains location information of a parcel P to be delivered which is detected by a sensor 18.

At step S302, the control portion 142 moves the parcel P to a flat portion 105A of the first conveying passage 105 by driving a corresponding one of the moving devices 9A to 9E, using the location information of the parcel P obtained at step S300 and AI.

At step S304, the control portion 142 conveys the parcel P to the predetermined location 2A by driving conveying devices, etc., included in the first conveying passage 105 and the second conveying passage 108, whereby the parcel P is handed over to the delivery robot 15.

When the fallen parcel P is placed on the delivery robot 15, the delivery robot 15 goes down a slope which is set as a result of opening the door 13, and delivers the parcel P to a delivery destination, and thereafter returns to the autonomous vehicle 100.

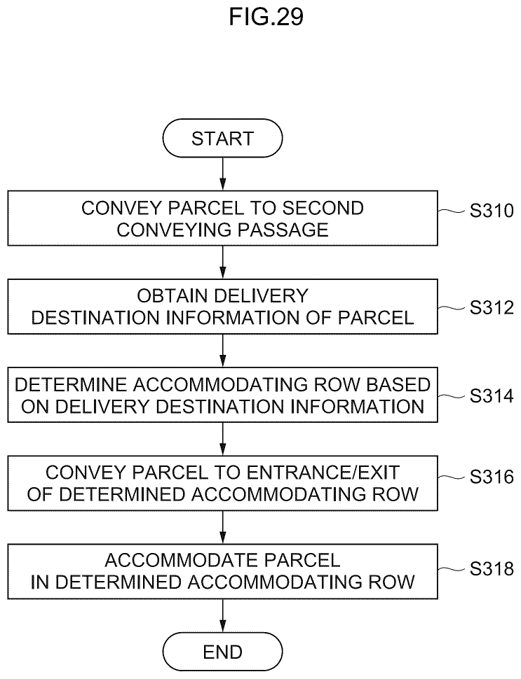

FIG. 29 is a diagram schematically showing an example of a processing routine performed by the information processing device upon loading a parcel in the third embodiment. In the case of loading a parcel P and accommodating the parcel P in any one of the accommodating portions 3A to 3C, the information processing device 14 repeatedly performs a flowchart shown in FIG. 29.

At step S310, a loaded parcel P is conveyed to the second conveying passage 108 by driving the conveying device 131 included in the third conveying passage 111.

At step S312, the information obtaining portion 140 obtains delivery destination information provided to the parcel P which is read by the sensor 18.

At step S314, the control portion 142 determines an accommodating row where the parcel P is to be accommodated, based on the delivery destination information.

At step S316, the control portion 142 conveys the parcel P to an entrance/exit of the accommodating row where the parcel P is to be accommodated, by driving conveying devices, etc., included in the first conveying passage 105 and the second conveying passage 108.

At step S318, the control portion 142 accommodates the parcel P in the accommodating row where the parcel P is to be accommodated, by driving a partial conveying device 120 in a flat portion 105A that is present at the entrance/exit of the accommodating row, such that the parcel P moves toward the accommodating row.

According to the third embodiment, a parcel P accommodated in any one of the accommodating portions 3A to 3C is conveyed to the bottom layer 1C of the carrier 1 by the first conveying passage 105, and further conveyed to the predetermined location 2A by the second conveying passage 108, and then handed over to the delivery robot 15. The delivery robot 15 delivers the parcel P to a delivery destination, and thereafter returns to the autonomous vehicle 100. Hence, unloading of a parcel P from the vehicle can be automatically performed, and delivery of the parcel P can be automatically performed. Therefore, labor costs for an unloading task can be saved.

Upon loading a parcel P into the carrier 1, the parcel P can be conveyed to a desired accommodating row by the third conveying passage 111, the second conveying passage 108, and the first conveying passage 105. Hence, loading of a parcel P into the vehicle can be automatically performed, whereby labor costs for a parcel loading task can also be saved.

Particularly, delivery destination information of a parcel P is read, one of the accommodating rows 4A to 4E of one of the accommodating portions 3A to 3C where the parcel P is to be accommodated is determined based on the read delivery destination information, and the parcel P is conveyed to the determined accommodating row and accommodated. Thus, parcels P are sorted and accommodated in the accommodating rows of the accommodating portions, according to delivery destinations. Hence, upon unloading, only a moving device included in an accommodating row of an accommodating portion where a parcel P to be unloaded is accommodated is driven. Thus, for example, a reduction in battery capacity for driving the moving device can be prevented.

The door 13 is provided in the space 2 so that the door 13 functions as a slope for the delivery robot 15 to enter or exit the autonomous vehicle 100. Hence, in addition to anti-theft measures for the autonomous vehicle 100, entering or exiting of the delivery robot 15 can be easily performed.

There may be a case in which upon loading a parcel P into the carrier 1, since an accommodating row determined according to a delivery destination of the parcel P is full, the parcel P cannot be accommodated in the accommodating row determined according to the delivery destination. In such a case, the parcel P to be loaded is loaded into an accommodating row where a parcel P whose delivery destination is close to the delivery destination of the parcel P is accommodated. Alternatively, the parcel P to be loaded is loaded into an accommodating row present near the accommodating row determined according to the delivery destination of the parcel P. In a case in which both accommodating rows are full of parcels P, the parcel P to be loaded is accommodated in an accommodating row that can still accommodate a parcel P.

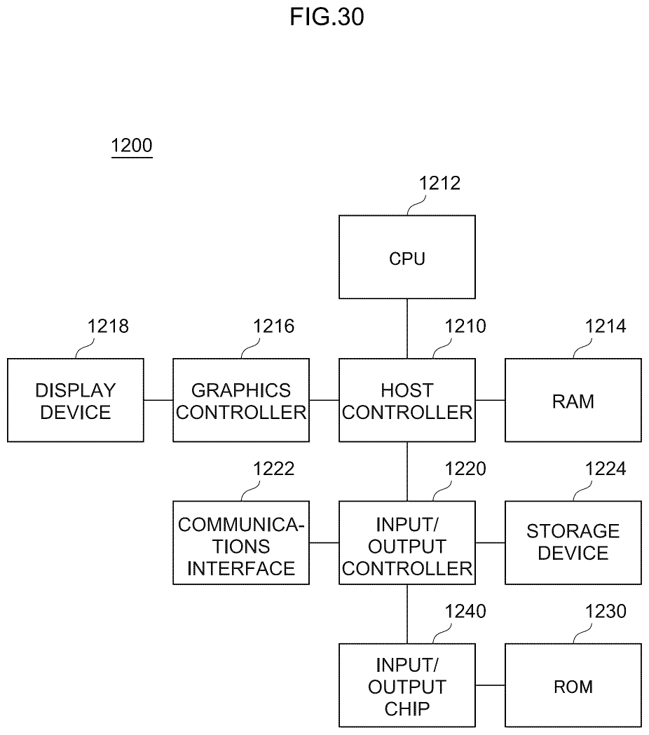

FIG. 30 schematically shows an example of a hardware configuration of a computer 1200 that functions as the information processing device 14. A program installed on the computer 1200 can cause the computer 1200 to function as one or a plurality of “portions” of devices according to the present embodiments, or can cause the computer 1200 to perform operations related to the devices according to the embodiments or perform the one or plurality of “portions”, and/or can cause the computer 1200 to perform processes according to the embodiments or processing steps in the processes. Such a program may be executed by a CPU 1212 so that the computer 1200 can perform specific operations related to some or all of blocks in flowcharts and block diagrams which are shown in the present specification.

The computer 1200 of the present embodiments includes the CPU 1212, a RAM 1214, and a graphics controller 1216, which are connected to each other by a host controller 1210. The computer 1200 also includes input/output units such as a communications interface 1222, a storage device 1224, a DVD drive, and an IC card drive, which are connected to the host controller 1210 through an input/output controller 1220. The DVD drive may be, for example, a DVD-ROM drive and a DVD-RAM drive. The storage device 1224 may be, for example, a hard disk drive and a solid state drive. The computer 1200 also includes input/output units such as a ROM 1230 and a keyboard, which are connected to the input/output controller 1220 through an input/output chip 1240.

The CPU 1212 operates in accordance with programs stored in the ROM 1230 and the RAM 1214, thereby controlling each unit. The graphics controller 1216 obtains image data generated by the CPU 1212 in, for example, a frame buffer provided in the RAM 1214 or in itself, so that the image data is displayed on a display device 1218.

The communications interface 1222 communicates with other electronic devices through a network. The storage device 1224 stores programs and data which are used by the CPU 1212 in the computer 1200. The DVD drive reads a program or data from a DVD-ROM or the like, and provides the program or the data to the storage device 1224. The IC card drive reads a program and data from an IC card, and/or writes a program and data into an IC card.

The ROM 1230 stores therein, for example, a boot program which is executed by the computer 1200 upon activation, and/or a program that depends on hardware of the computer 1200. The input/output chip 1240 may also connect various input/output units to the input/output controller 1220 through, for example, a USB port, a parallel port, a serial port, a keyboard port, or a mouse port.

Programs are provided by a computer-readable storage medium such as a DVD-ROM or an IC card. Programs are read from a computer-readable storage medium, installed in the storage device 1224, the RAM 1214, or the ROM 1230 which is also an example of a computer-readable storage medium, and executed by the CPU 1212. Information processing described in the programs is read by the computer 1200, thereby interfacing between the programs and the above-described various types of hardware resources. A device or a method may be formed by implementing operations or processes of information along with use of the computer 1200.

For example, in a case in which communication is performed between the computer 1200 and an external device, the CPU 1212 may execute a communication program loaded into the RAM 1214, and instruct the communications interface 1222 to perform a communication process, based on processes described in the communication program. Under the control of the CPU 1212, the communications interface 1222 reads transmit data stored in a transmit buffer area provided in a recording medium such as the RAM 1214, the storage device 1224, a DVD-ROM, or an IC card, and transmits the read transmit data to a network, or writes receive data received from the network into, for example, a receive buffer area provided in the recording medium.

The CPU 1212 may cause the RAM 1214 to read all or a necessary portion of files or databases stored in an external recording medium such as the storage device 1224, a DVD drive (DVD-ROM), or an IC card, and perform various types of processes on data on the RAM 1214. The CPU 1212 may then write back the processed data into the external recording medium.

Various types of information such as various types of programs, data, tables, and databases may be stored in a recording medium and subjected to information processing. The CPU 1212 may perform various types of processes including, for example, various types of operations, information processing, conditional judgement, conditional branching, unconditional branching, and information search/replace, which are described throughout the present disclosure and are specified by a program's instruction sequence, on data read from the RAM 1214, and writes back results into the RAM 1214. The CPU 1212 may retrieve information in files, databases, and the like, in a recording medium. For example, in a case in which a plurality of entries each having an attribute value of a first attribute that is associated with an attribute value of a second attribute are stored in a recording medium, the CPU 1212 may retrieve, from among the plurality of entries, an entry whose attribute value of the first attribute matches a specified condition, and read an attribute value of the second attribute stored in the entry, whereby the attribute value of the second attribute associated with the first attribute that satisfies the predetermined condition may be obtained.

The above-described programs or software modules may be stored on the computer 1200 or in a computer-readable storage medium near the computer 1200. A recording medium such as a hard disk or a RAM that is provided in a server system connected to a dedicated communication network or the Internet can be used as a computer-readable storage medium, whereby programs are provided to the computer 1200 through the network.

Blocks in flowcharts and block diagrams in the present embodiments may represent processing steps in processes where operations are performed, or represent “portions” of devices having a role in performing operations. A specific processing step and “portion” may be implemented by a dedicated circuit, a programmable circuit that is supplied with computer-readable instructions stored on a computer-readable storage medium, and/or a processor that is supplied with computer-readable instructions stored on a computer-readable storage medium. The dedicated circuit may include a digital and/or analog hardware circuit, and may include an integrated circuit (IC) and/or a discrete circuit. The programmable circuit may include, for example, a reconfigurable hardware circuit including AND, OR, exclusive OR, NAND, NOR, and other logical operations, a flip-flop, a register, and a memory element. Examples of the programmable circuit include a field-programmable gate array (FPGA) and a programmable logic array (PLA).

The computer-readable storage medium may include any tangible device that can store instructions to be executed by an appropriate device. As a result, the computer-readable storage medium having instructions stored therein includes a product including instructions that can be executed to create means for performing operations specified in a flowchart or a block diagram. Examples of the computer-readable storage medium may include an electronic storage medium, a magnetic storage medium, an optical storage medium, an electromagnetic storage medium, and a semiconductor storage medium. More specific examples of the computer-readable storage medium may include a FLOPPY (registered trademark) disk, a diskette, a hard disk, a random-access memory (RAM), a read-only memory (ROM), an erasable programmable read-only memory (an EPROM or a flash memory), an electrically erasable programmable read-only memory (EEPROM), a static random-access memory (SRAM), a compact disc read-only memory (CD-ROM), a digital versatile disc (DVD), a BLU-RAY (registered trademark) disc, a memory stick, and an integrated circuit card.

The computer-readable instructions may include any of an assembler instruction, an instruction set architecture (ISA) instruction, a machine instruction, a machine-dependent instruction, microcode, a firmware instruction, state-setting data, and source code and object code which are written in one programming language or in any combination of a plurality of programming languages that include object-oriented programming languages such as SMALLTALK (registered trademark), JAVA (registered trademark), and C++, and conventional procedural programming languages such as a “C” programming language or similar programming languages.

Computer-readable instructions may be provided to a general-purpose computer, a special-purpose computer, a processor of any other programmable data processing device, or a programmable circuit locally or through a local-area network (LAN) or a wide area network (WAN) such as the Internet, so that the general-purpose computer, the special-purpose computer, the processor of any other programmable data processing device, or the programmable circuit executes the computer-readable instructions to create means for performing operations specified in a flowchart or a block diagram. Examples of the processor include a computer processor, a processing unit, a microprocessor, a digital signal processor, a controller, and a microcontroller.

The present disclosure has been described above using the embodiments; however, the technical scope of the present disclosure is not limited to the scope described in the embodiments. It is obvious to a person skilled in the art that various changes or modifications can be added to the embodiments. It is obvious from the recitation in the claims that embodiments to which such changes or modifications are added can also be included in the technical scope of the disclosure.

It is to be noted that the order of performing processes, such as operations, procedures, steps, and processing steps for devices, systems, programs, and methods which are shown in the claims, the specification, and the drawings, can be implemented in any order unless explicitly stated otherwise like, for example, “before” or “prior to” or unless otherwise an output obtained in a given process is used in a subsequent process. Even if an operation flow in the claims, the specification, and the drawings has been described using the words “first,”, “next,”, and the like, for the sake of convenience, it does not mean that the operation flow needs to be performed in this order.

Disclosure of Japanese Patent Application No. 2023-007931 filed on Jan. 23, 2023, disclosure of Japanese Patent Application No. 2023-025537 filed on Feb. 21, 2023, and disclosure of Japanese Patent Application No. 2023-026722 filed on Feb. 22, 2023 are entirely incorporated herein by reference.

### DESCRIPTION OF REFERENCE NUMERALS

1: Carrier, 2: Space, 3A to 3C: Accommodating portion, 4A to 4E: Accommodating row, 5: Conveying passage, 5A: Slope, 5B: Flat portion, 7: Conveying device, 8: Hand-over portion, 9A to 9E: Moving device, 10 and 100: Autonomous vehicle, 12: Drive device, 13: Door, 14: Information processing device, 15: Delivery robot, 18: Sensor, 20: Moving device, 105: First conveying passage, 108: Second conveying passage, 120: Partial conveying device, 1200: Computer, 1210: Host controller, 1212: CPU, 1214: RAM, 1216: Graphics controller, 1218: Display device, 1220: Input/output controller, 1222: Communications interface, 1224: Storage device, 1230: ROM, and 1240: Input/output chip

1. A carrier for a vehicle, the carrier comprising:
a plurality of accommodating portions that are layered and that accommodate a parcel;
a conveying passage provided around the plurality of accommodating portions in a spiral manner to couple together the accommodating portions, thereby conveying the parcel to one of the accommodating portions in a lower layer, the accommodating portions being adjacent to each other;
a moving device that moves the parcel accommodated in any one of the accommodating portions to the conveying passage;
a hand-over portion that hands over the parcel to a predetermined location, the hand-over portion being provided in one of the accommodating portions in a bottom layer; and
an information processing device that controls the moving device such that the parcel is moved to the conveying passage and conveyed from one of the accommodating portions in a higher layer to the one of the accommodating portions in the bottom layer.

2. The carrier for a vehicle according to claim 1, wherein:
each of the accommodating portions has a plurality of accommodating rows, each of the accommodating rows accommodating a plurality of parcels in parallel, and
the moving device has an endless belt that moves the parcel from a corresponding one of the accommodating rows to the conveying passage.

3. The carrier for a vehicle according to claim 1, wherein at least a part of the conveying passage has a slope that causes the parcel to fall in a sliding manner, thereby conveying the parcel to one of the accommodating portions in a lower layer.

4. (canceled)

5. (canceled)

6. An automatic unloading system, comprising:
an autonomous vehicle including the carrier for a vehicle according to claim 1; and
a delivery robot for receiving the parcel and delivering the parcel to a delivery destination, the parcel having been handed over by the hand-over portion, and the delivery robot staying at the predetermined location.

7. A non-transitory computer-readable storage medium storing a program for causing a computer to function as the information processing device for the carrier for a vehicle according to claim 1.

8. A carrier for a vehicle, the carrier comprising:
a plurality of accommodating portions that are layered and that have a plurality of accommodating rows, each of the accommodating rows accommodating a plurality of parcels in parallel, the plurality of parcels each being provided with a piece of delivery destination information;
a conveying passage that conveys the parcel accommodated in any one of the accommodating portions in respective layers to a lower layer;
a sensor that reads the pieces of delivery destination information provided to the plurality of parcels;
a moving device that rearranges the parcels accommodated in each of the accommodating rows, and moves the parcels to the conveying passage in rearranged order;
a hand-over portion that hands over the parcel to a predetermined location, the parcel having been moved to the conveying passage and conveyed to a bottom layer; and
an information processing device that controls the moving device such that the parcels accommodated in the accommodating rows are rearranged based on a predetermined delivery route and the pieces of delivery destination information read by the sensor, and the parcels accommodated in the accommodating portions in the respective layers are moved to the conveying passage in the rearranged order and conveyed to the hand-over portion, wherein the moving device has a first moving device that lifts up the parcel and moves the parcel along a corresponding one of the accommodating rows, a second moving device that moves a parcel being accommodated in the corresponding one of the accommodating rows along the corresponding one of the accommodating rows, and a third moving device that moves a parcel accommodated in the corresponding one of the accommodating rows by pushing the parcel in a direction along the corresponding one of the accommodating rows.

9. (canceled)

10. (canceled)

11. (canceled)

12. (canceled)

13. The carrier for a vehicle according to claim 8, wherein the conveying passage is provided around the plurality of accommodating portions in a spiral manner.

14. An automatic unloading system, comprising:
an autonomous vehicle including the carrier for a vehicle according to claim 8; and
a delivery robot for receiving a parcel and delivering the parcel to a delivery destination, the parcel having been handed over by the hand-over portion, and the delivery robot staying at the predetermined location.

15. A non-transitory computer-readable storage medium storing a program for causing a computer to function as the information processing device for the carrier for a vehicle according to claim 8.

16. A carrier for a vehicle, the carrier comprising:
a plurality of accommodating portions that are layered and accommodate a parcel;
a first conveying passage that conveys the parcel accommodated in any one of the accommodating portions in respective layers to a lower layer, and conveys the parcel moved out from the lower layer to a higher layer;
a moving device that moves the parcel accommodated in any one of the accommodating portions to the first conveying passage, and moves the parcel from the first conveying passage to one of the accommodating portions in a predetermined layer;
a second conveying passage that conveys the parcel having been conveyed to a bottom layer to a predetermined location, and conveys the parcel moved out from the predetermined location to the first conveying passage;
a third conveying passage that conveys the parcel carried in from outside to the predetermined location, the third conveying passage being set so as to be retractable to the predetermined location; and
an information processing device that controls the first conveying passage, the second conveying passage, the third conveying passage, and the moving device such that the parcel carried in from the outside is conveyed to the predetermined location by the third conveying passage, the parcel moved out from the predetermined location is conveyed to the first conveying passage via the second conveying passage, the parcel is moved from the first conveying passage to the one of the accommodating portions in the predetermined layer, the parcel accommodated in any one of the accommodating portions is moved to the first conveying passage, with the third conveying passage retracted from the predetermined location, the parcel having been moved to the first conveying passage is conveyed to the second conveying passage, and the parcel having been conveyed to the second conveying passage is conveyed to the predetermined location.

17. The carrier for a vehicle according to claim 16, further comprising a sensor that reads delivery destination information provided to the parcel, wherein:
the information processing device controls the first conveying passage, the second conveying passage, the third conveying passage, and the moving device such that the parcel is accommodated in one of the accommodating portions that is determined in advance according to a delivery destination of the parcel, based on the delivery destination information read by the sensor.

18. The carrier for a vehicle according to claim 17, wherein:
each of the accommodating portions has a plurality of accommodating rows, each of accommodating rows accommodating a plurality of parcels in parallel, and
the information processing device controls the first conveying passage, the second conveying passage, the third conveying passage, and the moving device such that the parcel is accommodated in one of the accommodating rows of one of the accommodating portions that is determined according to a delivery destination of the parcel, based on the delivery destination information read by the sensor.

19. The carrier for a vehicle according to claim 16, wherein each of the first conveying passage, the second conveying passage, and the third conveying passage has a conveying device that conveys the parcels.

20. (canceled)

21. (canceled)

22. An automatic unloading system, comprising:
an autonomous vehicle including the carrier for a vehicle according to claim 16; and
a delivery robot for receiving the parcel and delivering the parcel to a delivery destination, the parcel having been handed over from the second conveying passage, and the delivery robot staying at the predetermined location, with a third conveying passage retracted.

23. A non-transitory computer-readable storage medium storing a program for causing a computer to function as the information processing device for the carrier for a vehicle according to claim 16.
